(19) United States
(12) Patent Application Publication
(10) Pub. No.: US 2024/0241711 A1
(43) Pub. Date: Jul. 18, 2024

(54) PHYSICAL RADIO SOFTWARE MANAGEMENT IN CLOUDS

(71) Applicant: Telefonaktiebolaget LM Ericsson (publ), Stockholm (SE)

(72) Inventor: Steve BAILLARGEON, Toronto (CA)

(21) Appl. No.: 18/559,886

(22) PCT Filed: May 13, 2022
(86) PCT No.: PCT/IB2022/054499

§ 371 Date: Nov. 9, 2023

Related U.S. Application Data
(60) Provisional application No. 63/188,812, filed on May 14, 2021.

(51) Int. Cl. G06F 8/65

(52) U.S. Cl. CPC G06F 8/65

(57) ABSTRACT

A first network node is described. The first network node is configured to communicate at least with a second network node. The first network node comprises processing circuitry configured to control at least a software version associated with at least a fourth network node by sending a job request that causes the second network 5 node to execute at least a job action associated with a software upgrade for at least the fourth network node. Other apparatuses, methods, and systems are disclosed.

### TECHNICAL FIELD

The present disclosure relates to wireless communications, and in particular, to management of software upgrade in wireless communication networks.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes (NNs), such as base stations, and mobile wireless devices (WD), as well as communication between network nodes and between WDs. In addition, 3GPP has developed standards for Radio Access Network RAN applications which run in running in access networks, e.g., cloud networks, and Kubernetes clusters.

Kubernetes (k8s) is a system for running containers in an automated, declarative, repeatable, and understandable way. Kubernetes also provides a framework for deploying application code into production.

k8s cluster: A cluster in k8s consists of one or more master machines and multiple worker machines or nodes. The master runs the control plane functions, e.g., k8s Application Programming Interface (API), and coordinates between all the nodes running the actual workloads knowns as pods.

k8s pod: A pod in k8s is the smallest unit of deployment in a cluster, i.e., a pod may be an instance of an application. A pod could run on a single container or multiple containers. Each pod has a unique Internet Protocol (IP) address assigned. If a pod is running on multiple containers, then the containers can communicate with each other using localhost. When containers must communicate outside the pod, a User Datagram Protocol (UDP) or a Transmission Control Protocol (TCP) port is exposed. A pod is usually deployed with a controller. Examples of controllers supported in k8s include a Deployment, a StatefulSet, DaemonSet and a Job.

k8s Job: Most cloud Radio Access Network (RAN) applications are long-running workloads, Deployments, that eventually need to be software upgraded and are present in a k8s clusters for as long as the services are needed. Jobs in k8s are designed for short-lived workloads, e.g., one-off tasks in a k8s cluster. Jobs are useful for tasks/processes that are to be performed once. A Job in k8s creates a pod that runs until successful termination, e.g., exit with 0, but is not automatically deleted by default, unless configured to do so. Keeping jobs allows users to view logs of completed pods to check for errors, warnings, and/or other diagnostic output.

k8s node: A node is a worker machine. For example, a node may be a Virtual Machine (VM) or a physical machine which contains services to run pods. A work machine is controlled by a master which coordinates between nodes. Each node has knowledge of its Central Processing Unit (CPU), Graphical Processing Unit (GPU), memory, ephemeral storage, and maximum number of pods which can be scheduled on the node.

Cluster user: a cluster user in k8s is a user from a group of users responsible for creating and managing specific application instances, e.g., tenant pods or workloads, running in a multi-cluster network.

Cluster admin: a group of users responsible for creating and managing k8s clusters and related physical components and operating system.

Orchestrator: The management system responsible for communicating with the k8s clusters, e.g., via a k8s API interface, and managing the lifecycle of k8s resources including the workloads deployed as k8s Deployments, k8s StatefulSets, k8s DaemonSets and k8s Jobs.

FIG. 1 shows a typical process for managing and/or updating software on a network node (NN), e.g., a physical radio unit. Three network nodes, e.g., physical radio units, are shown and are connected directly or via a switched Ethernet network to one or more physical digital units (DUs). A new network node software version may be delivered in a large upgrade package that includes both DU software and network node software, e.g., physical radio unit software, that must be deployed together. The software upgrade procedure is managed and monitored using a vendor-specific DU element manager with vendor-specific managed objects requiring personnel trained in Radio Access Networks (RANs). During the software upgrade process, the DU activates a new DU software load, which typically causes service interruptions at least on the domain, i.e., DU+Radio software management domain. In addition, the DU downloads and activates the network node software load, e.g., physical radio unit software load, on each network node, e.g., physical radio unit, that is connected to the DU.

In sum, current network node software upgrade procedures interrupt service, e.g., systems, within the software management domain. In addition, current network node software upgrade procedures are cumbersome, time consuming, and require specific vendor element managers as well as trained personnel, e.g., radio engineers. As such, current procedures do not align with cloud native principles, nor do they provide for automation of software upgrade.

### SUMMARY

Some embodiments advantageously provide methods, systems, and apparatuses for managing software associated with network nodes, e.g., physical radio units, in an access network, e.g., a cloud network, k8s clusters.

In some other embodiments, two RAN implementations are described. The two RAN applications may be running in an access network, e.g., k8s cluster, and may work individually or as a pair for managing network node software, e.g., radio software on physical radio units. The two RAN applications are referred herein to as Radio Software Upgrade Job Controller (RSUJC) and Radio Software Upgrade Job Engine (RSUJE).

According to one aspect, a first network node configured to communicate at least with a second network node is described. The first network node comprises processing circuitry configured to control at least a software version associated with at least a fourth network node by sending a job request that causes the second network node to execute at least a job action associated with a software upgrade for at least the fourth network node.

In some embodiments, the processing circuitry is further configured to deploy a first job controller configured to perform the control of at least the software version, the deployed first job controller being one of a first type and a second type.

In some other embodiments, the first job controller is a Radio Software Upgrade Job Controller, RSUJC.

In one embodiment, the first network node is further configured to communicate with a third network node, the third network node being a management system. The first network node further comprising a communication interface configured to receive a request associated with the software upgrade from the third network node, the request causing the deployment of the first job controller. The processing circuitry is further configured to update a plurality of logs associated with the job action.

In another embodiment, the fourth network node is a radio unit having a radio interface and a local storage with a capacity for storing radio unit software, the radio unit software having a radio unit software version.

In some embodiments, the job request is any one of a create job request, a start job request, stop job request, and a delete job request. The create job request includes creating a job record associated with a job within an inventory. The start job request includes starting the job to make the job active within the second network node. The stop job request includes stopping the job to make the job inactive within the second network node. The delete job request includes deleting the job from the second network node and removing from the inventory the job record associated with the job.

In some other embodiments, the job action is any one of a load software precheck, a load software action, an activate software pre-check, an activate software action, and an activate software post-check. The load software precheck includes performing a software compatibility precheck at least on the fourth network node before one of downloading and activating a new software. The load software action includes downloading a new software version at least to the fourth network node. The activate software pre-check includes performing a precheck at least on the fourth network node before activating the new software. The activate software action includes activating the new software at least on the fourth network node. Further, the activate software post-check includes performing a post-check at least on the fourth network node after activating the new software.

In one embodiment, the second network node includes a deployed job engine, where the deployed job engine is a Radio Software Upgrade Job Engine (RUSJE) of the second type.

In another embodiment, the first type is a k8s Job running on a workload cluster, and the second type is a k8s Deployment running on a workload cluster.

In some embodiments, the first network node is any one of: configured based at least in part on a file; instantiated by the third network node; a standalone job controller; and running within one of the second network node and the third network node.

In some other embodiments, the file is Cloud Service Archive (CSAR).

In one embodiment, the first job controller is any job controller of a plurality of job controllers and is running on anyone of an element manager and a cloud management system.

In another embodiment, the method further includes subscribing to notifications by receiving and collecting information about a progress, a state and error conditions associated at least with the job action for at least the fourth network node.

According to another aspect, a method implemented in a first network node is described. The first network node is configured to communicate at least with a second network node. The method comprises controlling at least a software version associated with at least a fourth network node by sending a job request that causes the second network node to execute at least a job action associated with a software upgrade for at least the fourth network node.

In some embodiments, the method further includes deploying a first job controller configured to perform the control of at least the software version, the deployed first job controller being one of a first type and a second type.

In some other embodiments, wherein the first job controller is a Radio Software Upgrade Job Controller (RSUJC).

In one embodiment, the first network node is further configured to communicate with a third network node, the third network node being a management system. The method further includes: receiving a request associated with the software upgrade from the third network node, the request causing the deployment of the first job controller; and updating a plurality of logs associated with the job action.

In another embodiment, the fourth network node is a radio unit having a radio interface and a local storage with a capacity for storing radio unit software, the radio unit software having a radio unit software version.

In some embodiments, the job request is any one of a create job request, a start job request, stop job request, and a delete job request. The create job request includes creating a job record associated with a job within an inventory. The start job request includes starting the job to make the job active within the second network node. The stop job request includes stopping the job to make the job inactive within the second network node. The delete job request includes deleting the job from the second network node and removing from the inventory the job record associated with the job.

In some other embodiments, the job action is any one of a load software precheck, a load software action, an activate software pre-check, an activate software action, and an activate software post-check. The load software precheck includes performing a software compatibility precheck at least on the fourth network node before one of downloading and activating a new software. The load software action includes downloading a new software version at least to the fourth network node. The activate software pre-check includes performing a precheck at least on the fourth network node before activating the new software. The activate software action includes activating the new software at least on the fourth network node. Further, the activate software post-check includes performing a post-check at least on the fourth network node after activating the new software.

In one embodiment, the second network node includes a deployed job engine, where the deployed job engine is a Radio Software Upgrade Job Engine (RUSJE) of the second type.

In another embodiment, the first type is a k8s Job running on a workload cluster, and the second type is a k8s Deployment running on a workload cluster.

In some embodiments, the first network node is any one of: configured based at least in part on a file; instantiated by the third network node; a standalone job controller; and running within one of the second network node and the third network node.

In some other embodiments, the file is Cloud Service Archive (CSAR).

In one embodiment, the first job controller is any job controller of a plurality of job controllers and is running on anyone of an element manager and a cloud management system.

In another embodiment, the method further includes subscribing to notifications by receiving and collecting information about a progress, a state and error conditions associated at least with the job action for at least the fourth network node.

According to one aspect, a second network node configured to communicate at least with a first network node and a fourth network node is described. The second network node comprises a communication interface and processing circuitry. The communication interface is configured to receive a job request associated with a software upgrade for at least the fourth network node. The job request is received from the first network node and causes the second network node to execute at least a job action associated with the software upgrade. The processing circuitry is configured to execute the at least job action.

In some embodiments, a job engine is deployed within the second network node to execute at least the job action, where the deployed job engine is a Radio Software Upgrade Job Engine (RUSJE) of a first type, the first type being a k8s Deployment.

In some other embodiments, the second network node is further configured to communicate with a third network node, where the third network node is a management system. The communication interface is further configured to download to the fourth network node a radio unit software associated with the software upgrade. The fourth network node is a radio unit having a radio interface and a local storage with a capacity for storing the radio unit software. The radio unit software has a radio unit software version. The software upgrade is performed.

In one embodiment, the processing circuitry is further configured to cause the second network node to: write a record of a plurality of records to an inventory; and read the record of plurality of records from the inventory. Each record of the plurality of records is one of a network node record and a job record, and the inventory is one of a local database and a remote database.

In another embodiment, the processing circuitry is further configured to enable a Radio Software Upgrade Control Interface (RSUCI), the RSUCI generating a mapping between LCM operations and a plurality of signals and setting up a server socket for at least one network node to establish a connection as a client. The connection is a Transmission Control Protocol (TCP) connection over Transport Layer Security (TLS). The RSUCI allows the second network node to any one of: receive the job request to execute at least the job action; and transmit information about a progress, a state and error conditions associated at least with the job request for at least the fourth network node.

In some embodiments, the first network node is within the second network node.

In some other embodiments, the communication interface is further configured to: receive a dashboard request to read the record of the plurality of records from the inventory; and transmit the read record.

In one embodiment, the communication interface is further configured to fetch data from a fifth network node, where the fifth network node is a file server. The fetched data is associated with the software upgrade.

In another embodiment, the software upgrade is retrieved from a local storage.

In some embodiments, the communication interface is further configured to read a compatibility list from the fourth network node. The processing circuitry is further configured to determine whether the fourth network node is compatible with the software upgrade.

In some other embodiments, the processing circuitry is further configured to cause the second network node to write the record of a plurality of records to the inventory in response to an expiration of a heartbeat timer.

In one embodiment, the second network node is configured based at least in part on a file.

In another embodiment, the file is a Cloud Service Archive (CSAR).

In some embodiments, the job request is any one of a create job request, a start job request, stop job request, and a delete job request. The create job request includes creating a job record associated with a job within the inventory. The start job request includes starting the job to make the job active within the second network node. The stop job request includes stopping the job to make the job inactive within the second network node, and the delete job request includes deleting the job from the second network node and removing from the inventory the job record associated with the job.

In some other embodiments, in the processing circuitry is further configured to update a plurality of logs associated with the job action, and the communication interface is further configured to transmit notifications associated at least with the job action to the first network node.

According to another aspect, a method implemented in a second network node that is configured to communicate at least with a first network node and a fourth network node is described. The method includes: receiving a job request associated with a software upgrade for at least the fourth network node, the job request being received from the first network node and causing the second network node to execute at least a job action associated with the software upgrade; and executing the at least job action.

In some embodiments, the method further includes deploying a job engine within the second network node to execute at least the job action, where the deployed job engine is a Radio Software Upgrade Job Engine (RUSJE) of a first type, the first type being a k8s Deployment.

In some other embodiments, the second network node is further configured to communicate with a third network node, where the third network node is a management system. The method further includes downloading to the fourth network node a radio unit software associated with the software upgrade. The fourth network node is a radio unit having a radio interface and a local storage with a capacity for storing the radio unit software. The radio unit software has a radio unit software version. The method also includes performing the software upgrade.

In one embodiment, the method further includes: writing a record of a plurality of records to an inventory; and reading the record of plurality of records from the inventory. Each record of the plurality of records is one of a network node record and a job record, and the inventory is one of a local database and a remote database.

In another embodiment, the method further includes enabling a Radio Software Upgrade Control Interface (RSUCI), the RSUCI generating a mapping between LCM operations and a plurality of signals and setting up a server socket for at least one network node to establish a connection as a client. The connection is a Transmission Control Protocol (TCP) connection over Transport Layer Security (TLS). The RSUCI allows the second network node to any one of: receive the job request to execute at least the job action; and transmit information about a progress, a state and error conditions associated at least with the job request for at least the fourth network node.

In some embodiments, the first network node is within the second network node.

In some other embodiments, the method further includes: receiving a dashboard request to read the record of the plurality of records from the inventory; and transmitting the read record.

In one embodiment, the method further includes fetching data from a fifth network node (16e), where the fifth network node is a file server. The fetched data is associated with the software upgrade.

In another embodiment, the software upgrade is retrieved from a local storage. In some embodiments, the method further includes: reading a compatibility list from the fourth network node; and determining whether the fourth network node (16d) is compatible with the software upgrade.

In some other embodiments, the method further includes writing the record of a plurality of records to the inventory in response to an expiration of a heartbeat timer.

In one embodiment, the second network node is configured based at least in part on a file.

In another embodiment, the file is a Cloud Service Archive (CSAR).

In some embodiments, the job request is any one of a create job request, a start job request, stop job request, and a delete job request. The create job request includes creating a job record associated with a job within the inventory. The start job request includes starting the job to make the job active within the second network node. The stop job request includes stopping the job to make the job inactive within the second network node, and the delete job request includes deleting the job from the second network node and removing from the inventory the job record associated with the job.

In some other embodiments, in the method further includes: updating a plurality of logs associated with the job action; and transmitting notifications associated at least with the job action to the first network node.

According to one aspect, a third network node configured to manage a software upgrade of at least a fourth network node is described. The third network node comprises a communication interface and processing circuitry. The communication interface is configured to receive at least a file associated with the software upgrade. The processing circuitry is configured to manage a life cycle of the software upgrade. The life cycle includes at least a job action associated at least with the software upgrade.

In some embodiments, the processing circuitry is configured to visualize at least the job action associated at least with the software upgrade.

In some other embodiments, at least the file associated with the software upgrade is received by an on-boarding manager, and visualizing at least the job action associated at least with the software upgrade is provided by a dashboard. The processing circuitry is further configured to manage logs associated with the software upgrade.

In one embodiment, receiving at least the file associated with the software upgrade includes receiving at least one of a software package, a software file, and a Cloud Service Archive (CSAR).

In another embodiment, managing the life cycle of the software upgrade includes causing the third network node to communicate with a first network node, the first network node being a Radio Software Upgrade Job Controller (RUSJC) and one of a standalone job controller and running within the third network node.

In some embodiments, the RUSJC is one of a k8s Job and a k8s Deployment.

In some other embodiments, managing the life cycle of the software upgrade further includes performing any one of: creating the job action associated at least with the software upgrade; inspecting the job action associated at least with the software upgrade; and deleting the job action associated at least with the software upgrade.

In one embodiment, visualizing at least the job action associated at least with the software upgrade includes any one of: requesting from a second network node (16b) at least a record associated with the software upgrade, the second network node (16b) being a Radio Software Upgrade Job Engine (RUSJE), the RSUJE being a k8s Deployment, the record being one of a network node record and a job record; and requesting software data associated with the software upgrade from a fifth network node, the fifth network node being a file server.

In another embodiment, the third network node is a management system, the management system being at least in part any one of an orchestrator and a k8s API server acting as the orchestrator within a k8s cluster when the first network node is instantiated.

According to another aspect, a method in a third network node configured to manage a software upgrade of at least a fourth network node is described. The method comprises: receiving at least a file associated with the software upgrade; and managing a life cycle of the software upgrade. The life cycle includes at least a job action associated at least with the software upgrade.

In some embodiments, the method further includes visualizing at least the job action associated at least with the software upgrade.

In some other embodiments, at least the file associated with the software upgrade is received by an on-boarding manager, and visualizing at least the job action associated at least with the software upgrade is provided by a dashboard. The method further includes managing logs associated with the software upgrade.

In one embodiment, receiving at least the file associated with the software upgrade includes receiving at least one of a software package, a software file, and a Cloud Service Archive (CSAR).

In another embodiment, managing the life cycle of the software upgrade includes causing the third network node to communicate with a first network node, the first network node being a Radio Software Upgrade Job Controller (RUSJC) and one of a standalone job controller and running within the third network node.

In some embodiments, the RUSJC is one of a k8s Job and a k8s Deployment.

In some other embodiments, managing the life cycle of the software upgrade further includes performing any one of: creating the job action associated at least with the software upgrade; inspecting the job action associated at least with the software upgrade; and deleting the job action associated at least with the software upgrade.

In one embodiment, visualizing at least the job action associated at least with the software upgrade includes any one of: requesting from a second network node at least a record associated with the software upgrade, the second network node being a Radio Software Upgrade Job Engine (RUSJE), the RSUJE being a k8s Deployment, the record being one of a network node record and a job record; and requesting software data associated with the software upgrade from a fifth network node, the fifth network node being a file server.

In another embodiment, the third network node is a management system, the management system being at least in part any one of an orchestrator and a k8s API server acting as the orchestrator within a k8s cluster when the first network node is instantiated.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 shows a diagram of a legacy process of radio software management;

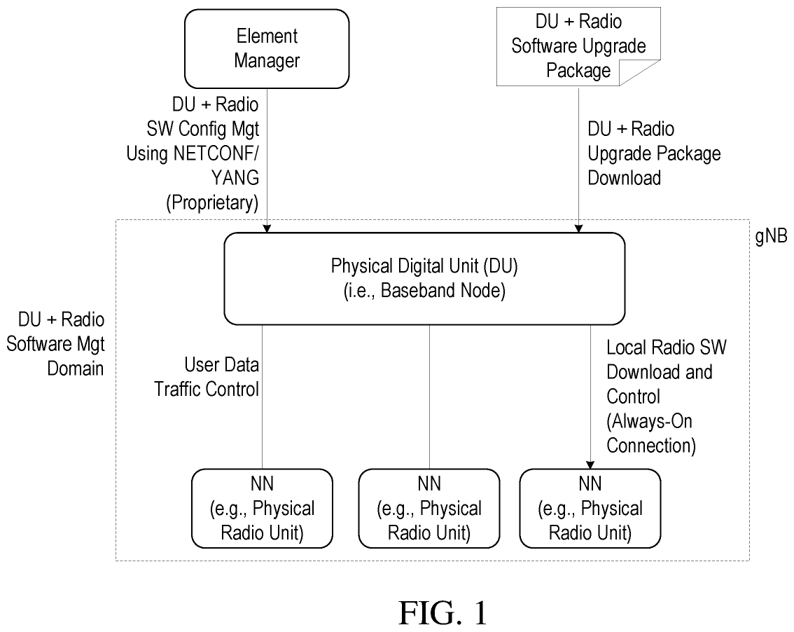

FIG. 2 is a schematic diagram of an example network architecture illustrating a communication system according to principles disclosed herein;

FIG. 3 is a block diagram of a network node in communication with a wireless device over a wireless connection according to some embodiments of the present disclosure;

FIG. 4 is a flowchart of an example process in a network node for controlling at least a software version according to some embodiments of the present disclosure;

FIG. 5 is a flowchart of an example process in a network node for executing at least a job action associated with a software upgrade according to some embodiments of the present disclosure;

FIG. 6 is a flowchart of an example process in a network node for managing a life cycle of a software upgrade according to some embodiments of the present disclosure;

FIG. 7 is a flowchart of another example process in a network node for controlling at least a software version according to some embodiments of the present disclosure;

FIG. 8 is a flowchart of another example process in a network node for executing at least a job action associated with a software upgrade according to some embodiments of the present disclosure;

FIG. 9 is a flowchart of another example process in a network node for managing a life cycle of a software upgrade according to some embodiments of the present disclosure;

FIG. 10 is a diagram of an example process for downloading network node software, e.g., radio software according to some embodiments of the present disclosure;

FIG. 11 is a diagram of another example process for downloading network node software, e.g., radio software, according to some embodiments of the present disclosure;

FIG. 12 is diagram of an example Radio Software Upgrade Job Controller (RSUJC) realized as a k8s Job according to some embodiments of the present disclosure;

FIG. 13 is diagram of an example RSUJC realized as a k8s Deployment according to some embodiments of the present disclosure;

FIG. 14 is a diagram of another example RSUJC realized as a k8s Job according to some embodiments of the present disclosure;

FIG. 15 is diagram of another example RSUJC realized as a k8s Deployment according to some embodiments of the present disclosure;

FIG. 16 is diagram of an example process to automatically visualize a network node inventory, e.g., radio unit records, in real-time on a cloud dashboard according to some embodiments of the present disclosure;

FIG. 17 is diagram of an example process to automatically visualize a software upgrade job inventory, such as job records, in real-time on a cloud dashboard according to some embodiments of the present disclosure;

FIG. 18 is diagram of an example process to automatically visualize content of a network node software repository, e.g., radio LMCs, on a cloud dashboard according to some embodiments of the present disclosure;

FIG. 19 is an overview of an example process of FIGS. 19A-19D according to some embodiments of the present disclosure;

FIG. 19A is a diagram of an example process of job creation at startup according to some embodiments of the present disclosure;

FIG. 19B is diagram of an example process of fetching data from a server according to some embodiments of the present disclosure;

FIG. 19C is a diagram of an example process of selecting network node units for the job and checking network node compatibility according to some embodiments of the present disclosure;

FIG. 19D is a diagram of an example process of job termination, inspection, and cleanup according to some embodiments of the present disclosure;

FIG. 20 is an overview of an example process of FIGS. 20A-20D according to some embodiments of the present disclosure;

FIG. 20A is a diagram of another example process of job creation and start up according to some embodiments of the present disclosure;

FIG. 20B is a diagram of another example process of fetching software from a server according to some embodiments of the present disclosure;

FIG. 20C is a diagram of an example process of selecting network node units for the job, and loading and activating software according to some embodiments of the present disclosure;

FIG. 20D is a diagram of an example process example of job termination, inspection, and cleanup according to some embodiments of the present disclosure;

FIG. 21 is an overview of an example process of FIGS. 21A-21D according to some embodiments of the present disclosure;

FIG. 21A is a diagram of an example process of getting a compatibility list, resolving a Load Module (LM) for a network node, e.g., a radio unit, and performing automatic job creation and startup according to some embodiments of the present disclosure;

FIG. 21B is a diagram of an example process of fetching network node software, e.g., radio software according to some embodiments of the present disclosure;

FIG. 21C is a diagram of an example process of loading and activating network node software, e.g., radio software, according to some embodiments of the present disclosure; and

FIG. 21D is a diagram of another example process example of job termination, inspection, and cleanup according to some embodiments of the present disclosure.

### DETAILED DESCRIPTION

Before describing in detail example embodiments, it is noted that the embodiments reside primarily in combinations of apparatus components and processing steps related to management of radio software in cloud networks. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising.” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), a RSUJC, a RSUJE, a job engine service which may include an RSUJE, a management system, a file server, a file system, a radio unit (RU) such as a physical RU, a centralized unit (CU) (e.g., physical CU, virtual CU (vCU)), a digital/distributed unit (e.g., physical DU, virtual DU (vDU)), an inventory node, etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IOT) device, or a Narrowband IoT (NB-IOT) device etc.

As used herein, the term “upgrade” within the context of a software upgrade is not limited solely to moving from one version of software to a more recent version or to a version that includes new features, etc. Rather, as used herein, the term “upgrade” within the context of a software upgrade refers to moving from one version of software to another.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

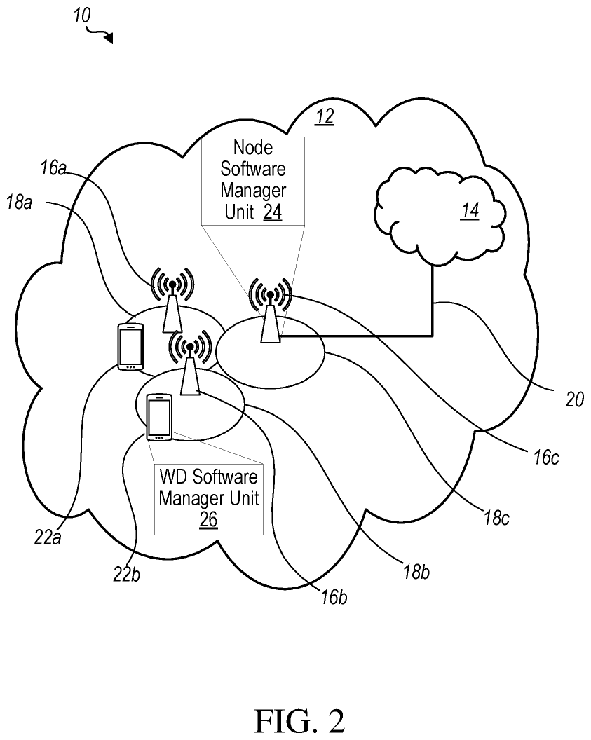

Some embodiments are directed to management of radio software in cloud networks. Referring again to the drawing figures, in which like elements are referred to by like reference numerals, there is shown in FIG. 2 a schematic diagram of a communication system 10, according to an embodiment, such as a 3GPP-type cellular network that may support standards such as LTE and/or NR (5G), which comprises an access network 12, such as a radio access network, and a core network 14. Any of the access network 12 and core network 14 may refer to a cloud network such as a network configured to provide cloud computing services, processes, functions, features, etc. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

A network node 16 (e.g., RUSJE, RUSJC, eNB or gNB) is configured to include a node software manager unit 24 which is configured at least to control at least a job associated with software upgrade, execute the job, and manage a software upgrade cycle. A wireless device 22 is configured to include a WD software manager unit 26 which is configured to at least to control at least a job associated with software upgrade, execute the job, and manage a software upgrade cycle.

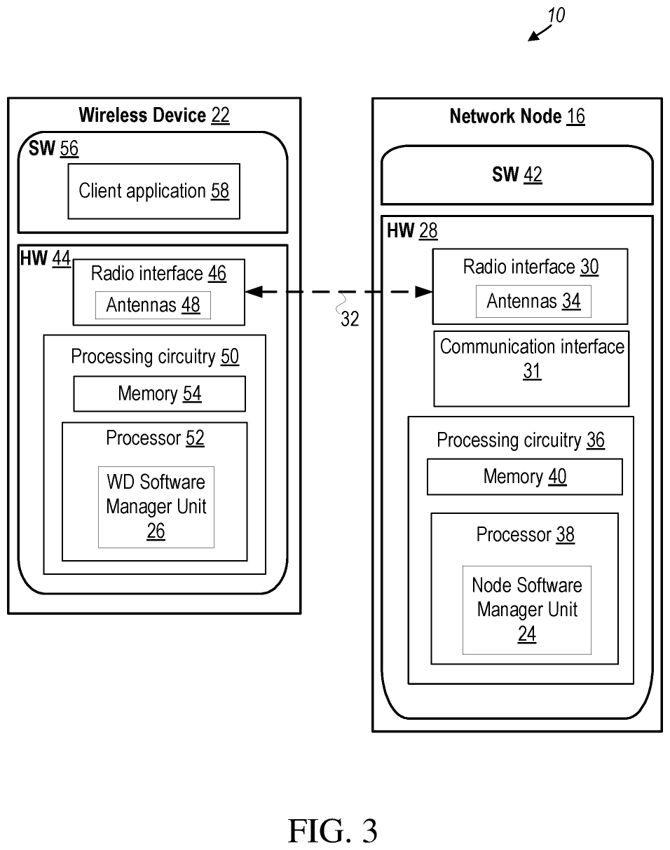

Example implementations, in accordance with an embodiment, of the WD 22 and network node 16 discussed in the preceding paragraphs will now be described with reference to FIG. 3.

The communication system 10 includes a network node 16 provided in a communication system 10 and including hardware 28 enabling it to communicate with the WD 22. The hardware 28 may include a radio interface 30 for setting up and maintaining at least a wireless connection 32 with a WD 22 located in a coverage area 18 served by the network node 16. The radio interface 30 may be formed as or may include, for example, one or more RF transmitters, one or more RF receivers, and/or one or more RF transceivers. The radio interface 30 includes an array of antennas 34 to radiate and receive signal(s) carrying electromagnetic waves. The hardware 28 may further include a communication interface 31 for setting up and maintaining a wireless/wired connection with any other node/device, e.g., another network node 16. The communication interface 31 may be formed as or may include, for example, one or more transmitters, one or more receivers, and/or one or more transceivers.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16. For example, processing circuitry 36 of the network node 16 may include node software manager unit 24 which is configured at least to control at least a job associated with software upgrade, execute the job, and manage a software upgrade cycle.

Although not show, it is noted that any network node 16 can be in communication and/or configured to communicate with any other network node 16, e.g., via a wired connection and/or wireless connection (such as by radio interface 30 and/or communication interface 31).

The communication system 10 further includes the WD 22 already referred to. The WD 22 may have hardware 44 that may include a radio interface 46 configured to set up and maintain a wireless connection 32 with a network node 16 serving a coverage area 18 in which the WD 22 is currently located. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

The hardware 44 of the WD 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 56, which is stored in, for example, memory 54 at the WD 22, or stored in external memory (e.g., database, storage array, network storage device, etc.) accessible by the WD 22. The software 56 may be executable by the processing circuitry 50. The software 56 may include a client application 58. The client application 58 may be operable to provide a service to a human or non-human user via the WD 22.

The processing circuitry 50 may be configured to control any of the methods and/or processes described herein and/or to cause such methods, and/or processes to be performed, e.g., by WD 22. The processor 52 corresponds to one or more processors 52 for performing WD 22 functions described herein. The WD 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to WD 22. For example, the processing circuitry 50 of the wireless device 22 may include a WD software manager unit 26 which is configured at least to control at least a job associated with software upgrade, execute the job, and manage a software upgrade cycle.

In some embodiments, the inner workings of the network node 16 and WD 22 may be as shown in FIG. 3 and independently, the surrounding network topology may be that of FIG. 2.

The wireless connection 32 between the WD 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Although FIGS. 2 and 3 show various “units” such as node software manager unit 24 and WD software manager unit 26 as being within a respective processor, it is contemplated that these units may be implemented such that a portion of the unit is stored in a corresponding memory within the processing circuitry. In other words, the units may be implemented in hardware or in a combination of hardware and software within the processing circuitry.

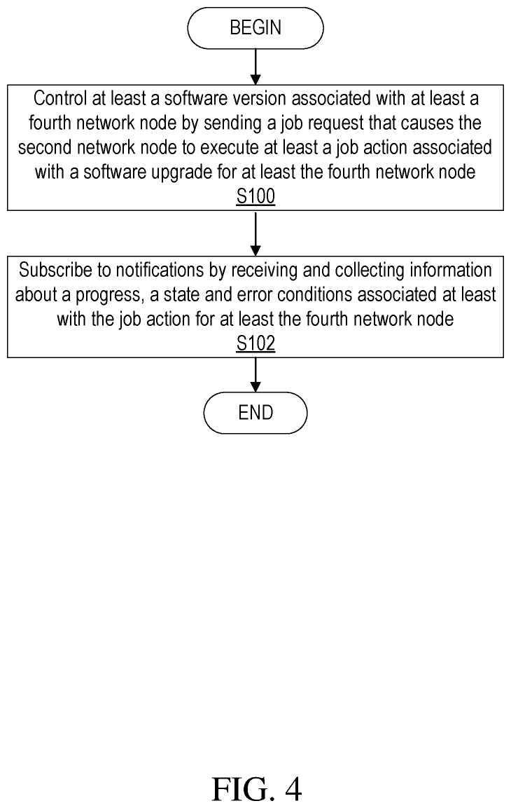

FIG. 4 is a flowchart of an example process in a network node 16, e.g., a first network node 16a, for controlling at least a software version. One or more blocks described herein may be performed by one or more elements of network node 16 such as by one or more of processing circuitry 36 (including the node software manager unit 24), processor 38, and/or radio interface 30. The first network node 16a such as via processing circuitry 36 and/or processor 38 and/or radio interface 30 is configured to control (Block S100) at least a software version associated with at least a fourth network node by sending a job request that causes the second network node to execute at least a job action associated with a software upgrade for at least the fourth network node. Further, the first network node 16a such as via processing circuitry 36 and/or processor 38 and/or radio interface 30 is configured to subscribe (Block S102) to notifications by receiving and collecting information about a progress, a state and error conditions associated at least with the job action for at least the fourth network node.

In some embodiments, the first network node 16a and/or processing circuitry 36 and/or radio interface 30 is further configured to deploy a first job controller configured to perform the control of at least the software version. The deployed first job controller is one of a first type and a second type.

In an embodiment, the first network node 16a and/or processing circuitry 36 and/or radio interface 30 is further configured to communicate with a third network node 16c. The third network node 16c is a management system, and the fourth network node 16d is a radio unit that has a radio interface and a local storage with a capacity for storing radio unit software. The radio unit software having a radio unit software version. The first network node 16a and/or processing circuitry 36 and/or radio interface 30 is further configured to receive a request associated with the software upgrade from the third network node, where the request causes the deployment of the first job controller, and update a plurality of logs associated with the job action. The first job controller is a Radio Software Upgrade Job Controller (RSUJC).

In some other embodiments, the job request is any one of a create job request, a start job request, stop job request, and a delete job request. The create job request includes creating a job record associated with a job within an inventory. The start job request includes starting the job to make the job active within the second network node. The stop job request includes stopping the job to make the job inactive within the second network node. The delete job request includes deleting the job from the second network node 16b and removing from the inventory the job record associated with the job.

In one embodiment, the job action is any one of a load software precheck, a load software action, an activate software pre-check, an activate software action, and an activate software post-check. The load software precheck includes performing a software compatibility precheck at least on the fourth network node 16d before one of downloading and activating a new software. The load software action includes downloading a new software version at least to the fourth network node 16d. The activate software pre-check includes performing a precheck at least on the fourth network node 16d before activating the new software. The activate software action includes activating the new software at least on the fourth network node 16d. The activate software post-check includes performing a post-check at least on the fourth network node 16d after activating the new software.

In another embodiment, the second network node 16b includes a deployed job engine. The deployed job engine is a Radio Software Upgrade Job Engine (RUSJE) of the second type.

In some embodiments, the first type is a k8s Job running on a workload cluster, and the second type is a k8s Deployment running on a workload cluster.

In some other embodiments, the first network node 16a is any one of: configured based at least in part on a Cloud Service Archive (CSAR); instantiated by the third network node 16c; a standalone job controller; and running within one of the second network node 16b and the third network node 16c.

In one embodiment, the first job controller is any job controller of a plurality of job controllers and is running on anyone of an element manager and a cloud management system.

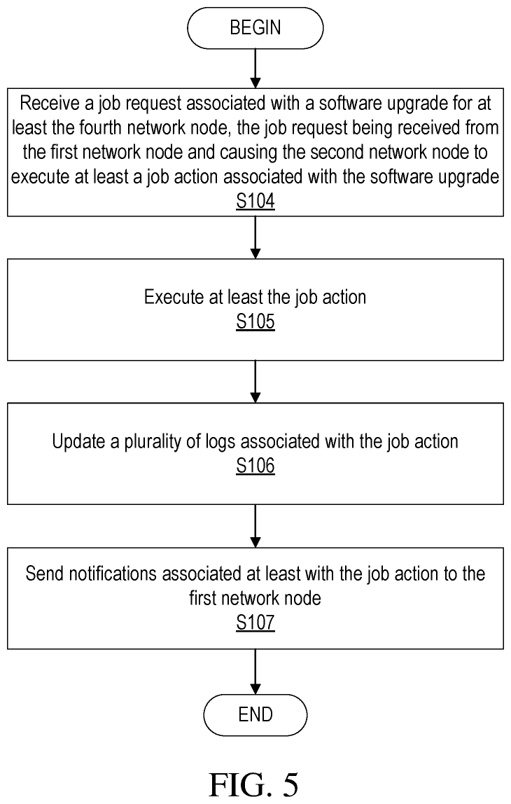

FIG. 5 is a flowchart of an example process in a network 16, e.g., a second network node 16b, for executing at least a job action associated with a software upgrade. One or more blocks described herein may be performed by one or more elements of network node 16 such as by one or more of processing circuitry 36 (including the node software manager unit 24), processor 38, and/or radio interface 30. The second network node 16b such as via processing circuitry 36 and/or processor 38 and/or radio interface 30 is configured to receive (Block S104) a job request associated with a software upgrade for at least the fourth network node 16d, the job request being received from the first network node 16a and causing the second network node 16b to execute at least a job action associated with the software upgrade. Further, the second network node 16b such as via processing circuitry 36 and/or processor 38 and/or radio interface 30 is configured to execute (Block S105) at least the job action, update (Block S106) a plurality of logs associated with the job action, and send (Block S107) notifications associated at least with the job action to the first network node 16a.

In some embodiments, the second network node 16b and/or processing circuitry 36 and/or radio interface 30 is further configured to deploy a job engine within the second network node 16b to execute at least the job action, where the deployed job engine is a Radio Software Upgrade Job Engine (RUSJE) of a first type, and the first type is a k8s Deployment.

In some other embodiments, the second network node 16b and/or processing circuitry 36 and/or radio interface 30 is further configured: communicate with a third network node 16c, where the third network node 16c is a management system; download to the fourth network node 16d a radio unit software associated with the software upgrade, where the fourth network node is a radio unit that has a radio interface and a local storage with a capacity for storing the radio unit software, the radio unit software having a radio unit software version; and cause the fourth network node 16d to perform the software upgrade.

In one embodiment, the second network node 16b and/or processing circuitry 36 and/or radio interface 30 is further configured to write a record of a plurality of records to an inventory and read the record of plurality of records from the inventory. Each record of the plurality of records is one of a network node record and a job record. The inventory is one of a local database and a remote database.

In another embodiment, the second network node 16b and/or processing circuitry 36 and/or radio interface 30 is further configured to enable a Radio Software Upgrade Control Interface (RSUCI), where the RSUCI generates a mapping between Life Cycle Management (LCM) operations and a plurality of signals, and sets up a server socket for at least one network node to establish a connection as a client. The connection is a Transmission Control Protocol (TCP) connection over Transport Layer Security (TLS) and allows the second network node 16b to any one of receive the job request to execute at least the job action and transmit information about a progress, a state and error conditions associated at least with the job request for at least the fourth network node 16d.

In some embodiments, the first network node 16a is within the second network node 16b.

In some other embodiments, the second network node 16b is further configured to receive a dashboard request to read the record of the plurality of records from the inventory and transmit the read record.

In one embodiment, the second network node 16b and/or processing circuitry 36 and/or radio interface 30 is further configured to fetch data from a fifth network node 16e, which is a file server. The fetched data is associated with the software upgrade.

In another embodiment, the software upgrade is retrieved from a local storage.

In some embodiments, the second network node 16b and/or processing circuitry 36 and/or radio interface 30 is further configured to read a compatibility list from the fourth network node 16d and determine whether the fourth network node 16d is compatible with the software upgrade.

In some other embodiments, the second network node 16b and/or processing circuitry 36 and/or radio interface 30 is further configured to write the record of a plurality of records to the inventory in response to an expiration of a heartbeat timer.

In some other embodiments, the second network node 16b is configured based at least in part on a Cloud Service Archive (CSAR).

In one embodiment, the job request is any one of a create job request, a start job request, stop job request, and a delete job request. The create job request includes creating a job record associated with a job within the inventory. The start job request includes starting the job to make the job active within the second network node. The stop job request includes stopping the job to make the job inactive within the second network node 16b, and the delete job request includes deleting the job from the second network node 16b and removing from the inventory the job record associated with the job.

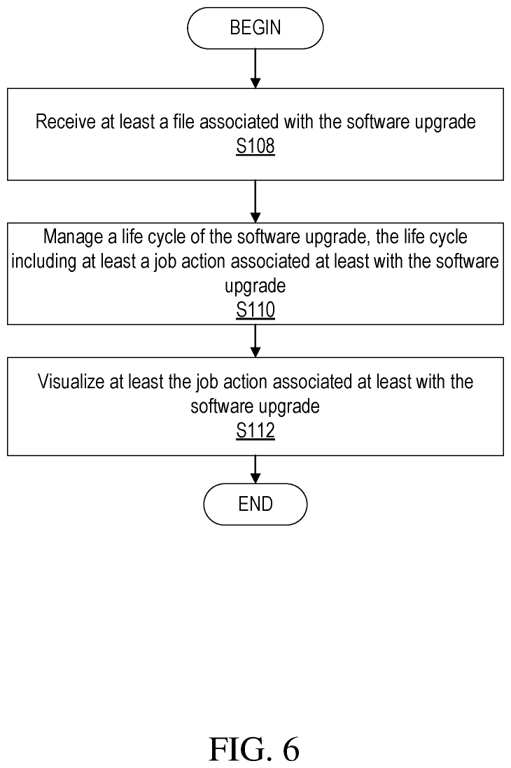

FIG. 6 is a flowchart of an example process in network 16, e.g., a third network node 16c, for managing a life cycle of a software upgrade. One or more blocks described herein may be performed by one or more elements of network node 16 such as by one or more of processing circuitry 36 (including the node software manager unit 24), processor 38, and/or radio interface 30. The third network node 16c such as via processing circuitry 36 and/or processor 38 and/or radio interface 30 is configured to receive (Block S108) at least a file associated with the software upgrade and manage (Block S110) a life cycle of the software upgrade, where the life cycle includes at least a job action associated at least with the software upgrade. Further, the third network node 16c such as via processing circuitry 36 and/or processor 38 and/or radio interface 30 is configured to visualize (Block S112) at least the job action associated at least with the software upgrade.

In some embodiments, at least the file associated with the software upgrade is received by an on-boarding manager and visualizing at least the job action associated at least with the software upgrade is provided by a dashboard. The third network node 16c is further configured to manage logs associated with the software upgrade.

In some other embodiments, receiving at least the file associated with the software upgrade includes receiving a Cloud Service Archive (CSAR).

In one embodiment, managing the life cycle of the software upgrade includes communicating with a first network node. The first network node 16a is a Radio Software Upgrade Job Controller (RUSJC) and one of a standalone job controller and running within the third network node. The RUSJC is one of a k8s Job and a k8s Deployment. Managing the life cycle of the software upgrade further includes performing any one of: creating the job action associated at least with the software upgrade; inspecting the job action associated at least with the software upgrade; and deleting the job action associated at least with the software upgrade.

In another embodiment, visualizing at least the job action associated at least with the software upgrade includes requesting from a second network node 16b at least a record associated with the software upgrade. The second network node is a Radio Software Upgrade Job Engine (RUSJE), which is a k8s Deployment, and the record is one of a network node record and a job record. In addition, software data associated with the software upgrade is requested from a fifth network node 16e, which is a file server.

In some embodiments, the third network node 16c is a management system, which is least in part any one of an orchestrator and a k8s API server acting as the orchestrator within a k8s cluster when the first network node is instantiated.

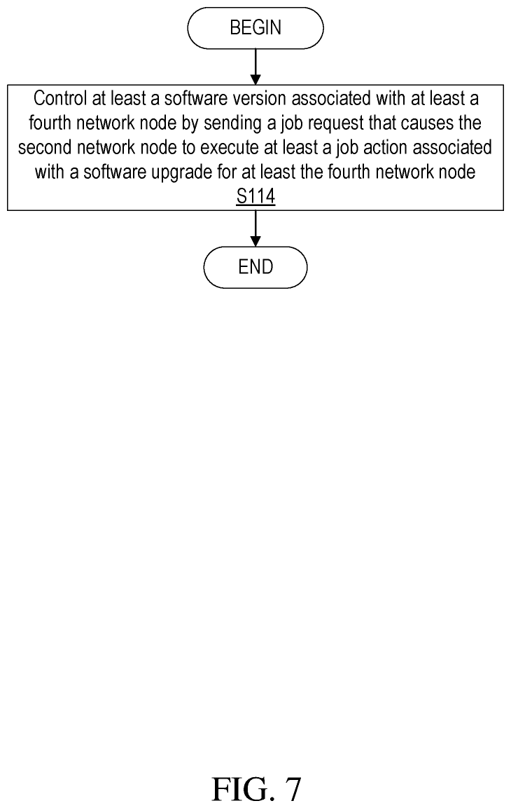

FIG. 7 is a flowchart of an example process in a network node 16, e.g., a first network node 16a, for controlling at least a software version. One or more blocks described herein may be performed by one or more elements of network node 16 such as by one or more of processing circuitry 36 (including the node software manager unit 24), processor 38, and/or radio interface 30. The first network node 16a such as via processing circuitry 36 and/or processor 38 and/or radio interface 30 is configured to control (Block S114) at least a software version associated with at least a fourth network node (16d) by sending a job request that causes the second network node (16b) to execute at least a job action associated with a software upgrade for at least the fourth network node (16d).

In some embodiments, the method further includes deploying a first job controller configured to perform the control of at least the software version, the deployed first job controller being one of a first type and a second type.

In some other embodiments, wherein the first job controller is a Radio Software Upgrade Job Controller (RSUJC).

In one embodiment, the first network node (16a) is further configured to communicate with a third network node (16c), the third network node (16c) being a management system. The method further includes: receiving a request associated with the software upgrade from the third network node (16c), the request causing the deployment of the first job controller; and updating a plurality of logs associated with the job action.

In another embodiment, the fourth network node (16d) is a radio unit having a radio interface and a local storage with a capacity for storing radio unit software, the radio unit software having a radio unit software version.

In some embodiments, the job request is any one of a create job request, a start job request, stop job request, and a delete job request. The create job request includes creating a job record associated with a job within an inventory. The start job request includes starting the job to make the job active within the second network node (16b). The stop job request includes stopping the job to make the job inactive within the second network node (16b). The delete job request includes deleting the job from the second network node (16b) and removing from the inventory the job record associated with the job.

In some other embodiments, the job action is any one of a load software precheck, a load software action, an activate software pre-check, an activate software action, and an activate software post-check. The load software precheck includes performing a software compatibility precheck at least on the fourth network node (16d) before one of downloading and activating a new software. The load software action includes downloading a new software version at least to the fourth network node (16d). The activate software pre-check includes performing a precheck at least on the fourth network node (16d) before activating the new software. The activate software action includes activating the new software at least on the fourth network node (16d). Further, the activate software post-check includes performing a post-check at least on the fourth network node (16d) after activating the new software.

In one embodiment, the second network node (16b) includes a deployed job engine, where the deployed job engine is a Radio Software Upgrade Job Engine (RUSJE) of the second type.

In another embodiment, the first type is a k8s Job running on a workload cluster, and the second type is a k8s Deployment running on a workload cluster.

In some embodiments, the first network node (16a) is any one of: configured based at least in part on a file; instantiated by the third network node (16c); a standalone job controller; and running within one of the second network node (16b) and the third network node (16c).

In some other embodiments, the file is Cloud Service Archive (CSAR).

In one embodiment, the first job controller is any job controller of a plurality of job controllers and is running on anyone of an element manager and a cloud management system.

In another embodiment, the method further includes subscribing to notifications by receiving and collecting information about a progress, a state and error conditions associated at least with the job action for at least the fourth network node (16d).

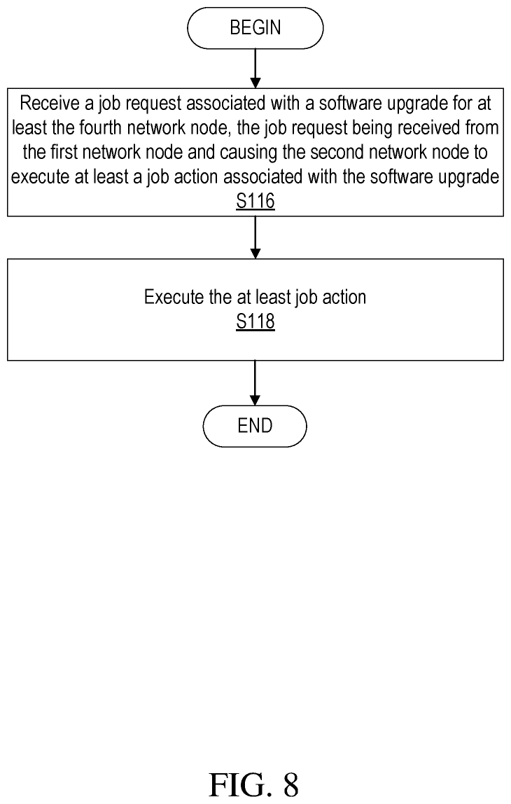

FIG. 8 is a flowchart of an example process in a network 16, e.g., a second network node 16b, for executing at least a job action associated with a software upgrade. One or more blocks described herein may be performed by one or more elements of network node 16 such as by one or more of processing circuitry 36 (including the node software manager unit 24), processor 38, and/or radio interface 30. The second network node 16b such as via processing circuitry 36 and/or processor 38 and/or radio interface 30 is configured to receive (Block S104) a job request associated with a software upgrade for at least the fourth network node (16d), the job request being received from the first network node (16a) and causing the second network node (16b) to execute at least a job action associated with the software upgrade; and execute (Block S118) the at least job action.

In some embodiments, the method further includes deploying a job engine within the second network node (16b) to execute at least the job action, where the deployed job engine is a Radio Software Upgrade Job Engine (RUSJE) of a first type, the first type being a k8s Deployment.

In some other embodiments, the second network node (16b) is further configured to communicate with a third network node (16c), where the third network node (16c) is a management system. The method further includes downloading to the fourth network node (16d) a radio unit software associated with the software upgrade. The fourth network node (16d) is a radio unit having a radio interface and a local storage with a capacity for storing the radio unit software. The radio unit software has a radio unit software version. The method also includes performing the software upgrade.

In one embodiment, the method further includes: writing a record of a plurality of records to an inventory; and reading the record of plurality of records from the inventory. Each record of the plurality of records is one of a network node record and a job record, and the inventory is one of a local database and a remote database.

In another embodiment, the method further includes enabling a Radio Software Upgrade Control Interface (RSUCI), the RSUCI generating a mapping between LCM operations and a plurality of signals and setting up a server socket for at least one network node to establish a connection as a client. The connection is a Transmission Control Protocol (TCP) connection over Transport Layer Security (TLS). The RSUCI allows the second network node (16b) to any one of: receive the job request to execute at least the job action; and transmit information about a progress, a state and error conditions associated at least with the job request for at least the fourth network node (16d).

In some embodiments, the first network node (16a) is within the second network node (16b).

In some other embodiments, the method further includes: receiving a dashboard request to read the record of the plurality of records from the inventory; and transmitting the read record.

In one embodiment, the method further includes fetching data from a fifth network node (16e), where the fifth network node (16e) is a file server. The fetched data is associated with the software upgrade.

In another embodiment, the software upgrade is retrieved from a local storage.

In some embodiments, the method further includes: reading a compatibility list from the fourth network node (16d); and determining whether the fourth network node (16d) is compatible with the software upgrade.

In some other embodiments, the method further includes writing the record of a plurality of records to the inventory in response to an expiration of a heartbeat timer.

In one embodiment, the second network node (16b) is configured based at least in part on a file.

In another embodiment, the file is a Cloud Service Archive (CSAR).

In some embodiments, the job request is any one of a create job request, a start job request, stop job request, and a delete job request. The create job request includes creating a job record associated with a job within the inventory. The start job request includes starting the job to make the job active within the second network node (16b). The stop job request includes stopping the job to make the job inactive within the second network node (16b), and the delete job request includes deleting the job from the second network node (16b) and removing from the inventory the job record associated with the job.

In some other embodiments, in the method further includes: updating a plurality of logs associated with the job action; and transmitting notifications associated at least with the job action to the first network node (16a).

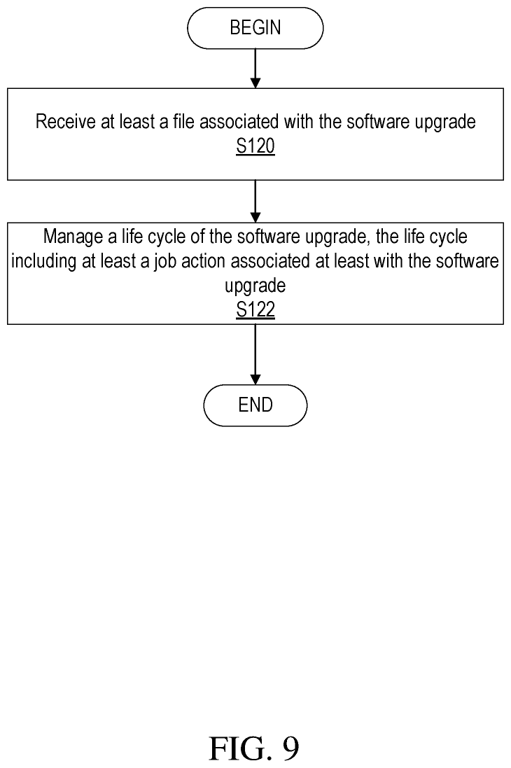

FIG. 9 is a flowchart of an example process in network 16, e.g., a third network node 16c, for managing a life cycle of a software upgrade. One or more blocks described herein may be performed by one or more elements of network node 16 such as by one or more of processing circuitry 36 (including the node software manager unit 24), processor 38, and/or radio interface 30. The third network node 16c such as via processing circuitry 36 and/or processor 38 and/or radio interface 30 is configured to receive (Block S120) at least a file associated with the software upgrade; and manage (Block S122) a life cycle of the software upgrade, where the life cycle includes at least a job action associated at least with the software upgrade.

In some embodiments, the method further includes visualizing at least the job action associated at least with the software upgrade.

In some other embodiments, at least the file associated with the software upgrade is received by an on-boarding manager, and visualizing at least the job action associated at least with the software upgrade is provided by a dashboard. The method further includes managing logs associated with the software upgrade.

In one embodiment, receiving at least the file associated with the software upgrade includes receiving at least one of a software package, a software file, and a Cloud Service Archive (CSAR).

In another embodiment, managing the life cycle of the software upgrade includes causing the third network node (16c) to communicate with a first network node (16a), the first network node (16a) being a Radio Software Upgrade Job Controller (RUSJC) and one of a standalone job controller and running within the third network node (16c).

In some embodiments, the RUSJC is one of a k8s Job and a k8s Deployment.

In some other embodiments, managing the life cycle of the software upgrade further includes performing any one of: creating the job action associated at least with the software upgrade; inspecting the job action associated at least with the software upgrade; and deleting the job action associated at least with the software upgrade.

In one embodiment, visualizing at least the job action associated at least with the software upgrade includes any one of: requesting from a second network node (16b) at least a record associated with the software upgrade, the second network node (16b) being a Radio Software Upgrade Job Engine (RUSJE), the RSUJE being a k8s Deployment, the record being one of a network node record and a job record; and requesting software data associated with the software upgrade from a fifth network node (16e), the fifth network node (16e) being a file server.

In another embodiment, the third network node (16c) is a management system, the management system being at least in part any one of an orchestrator and a k8s API server acting as the orchestrator within a k8s cluster when the first network node (16a) is instantiated.

Having described the general process flow of arrangements of the disclosure and having provided examples of hardware and software arrangements for implementing the processes and functions of the disclosure, the sections below provide details and examples of arrangements for management of radio software in cloud networks.

3GPP has defined RAN applications, e.g., virtualized Digital Unit (vDU), virtualized Central Unit Control Plane (vCU-CP) and virtualized Central Unit User Plane (vCU-UP), which are executed in access networks, such as cloud communication networks or k8s clusters. These RAN applications have created an opportunity to rethink how radio software is managed and delivered to network nodes, e.g., physical radio units, that are connected to vDUs.

Some embodiments provide one or more network nodes 16. Each network node 16 may be configured to perform a process associated with a job controller, such as a Radio Software Upgrade Job Controller (RSUJC), a job engine, such as a Radio Software Upgrade Job Engine (RSUJE), a management system, a radio unit, a file server, and an interface, such as an API server. However, each network node 16 is not limited to performing functions associated with a job controller, a job engine, a management system, a radio unit, a file server, and interface. Each network node 16 may perform any other process associated with software upgrade.

In some other embodiments, two RAN applications are described. The two RAN applications may be running in an access network, e.g., k8s cluster, and may work individually or as a pair for managing network node software, e.g., radio software on physical radio units. The two RAN applications are referred herein to as the Radio Software Upgrade Job Controller (RSUJC) and the Radio Software Upgrade Job Engine (RSUJE).

The RSUJC and the RSUJE may be deployed on one or more than one network node 16 located in the same access network 12 or different access network 12, e.g., k8s cluster or on different k8s clusters. In addition, the RSUJC and the RSUJE may be deployed in a management domain or in a radio access network. Although the RSUJC and the RSUJE may be deployed as described above, the RSUJC and the RSUJE are not limited to the deployments described and may be deployed in any network, including a combination of networks.

RSUJCs may be deployed on-demand, where each one of the RSUJCs requests a creation and/or start of a single job including information to perform the job. In a nonlimiting example, the information includes a matching criteria for selecting a network nodes 16 (e.g., radio units), target software version and job actions on network nodes 16. In a nonlimiting example, the deployment of a RSUJC may be explicitly defined by the user, e.g., using an orchestrator, or automatically. e.g., triggered by a system. The job can target a specific network node 16, e.g., radio unit or a collection of network nodes 16. Although RSUJCs are described as being deployed on-demand, RSUJCs are not limited to being deployed on demand and may be deployed once or in any other manner.

The RSUJE may be deployed once and may be part of a larger collection of other network node management services, e.g., radio management services. Multiple instances of an RSUJE may exist on one or more than one network node 16. Each network node 16, e.g., radio unit, may communicate with one RSUJE on another network node 16 at a time. The RSUJE executes, e.g., such as via processing circuitry 36, a vendor-specific upgrade logic based on instructions provided by each RSUJC over a Representational State Transfer (REST) Application Programming Interface (API) or Extensible Connection-oriented Messaging (XCM) interface. The RSUJE also may populate, such as via processing circuitry 36 and/or radio interface 30, an inventory with job records and product data associated with the network node 16 that is to be updated, e.g., product name, product number, product revision and serial number, as well as current and historical radio software versions loaded in each network node 16, e.g., radio unit.

In addition, a separate software delivery unit, e.g., on a network node 16, is described for on boarding network node software, e.g., radio software, into the management system. The network node software may be packaged in a separate Cloud Service Archive (CSAR) which is a cloud-based archive that may contain one or more Load Module Containers (LMCs) for a network node type, e.g., radio type, and/or network node product name, e.g., radio product name. A CSAR may also include additional information to help with design of run-time job configuration parameters for the Radio Software Upgrade Job Controller (RSUJC) of a network node 16, e.g., a network node 16 acting as an RSUJC. The additional information may include, but is not limited to, hardware and software compatibility lists as well as any possible dependencies with other Cloud RAN components.

The following is a nonlimiting list of advantages of the methods, apparatuses, and systems described in the present disclosure:
Using a vendor-specific element manager for physical radio software management is not required. Any cloud orchestrator may manage a lifecycle of a network node radio software, e.g., physical radio software. Any cloud dashboard may visualize progress of network node software upgrade jobs, e.g., radio software upgrade jobs, in real-time as well as visualize inventory of network nodes 16, e.g., radio units, managed by each RSUJE;
Software management of virtual RAN applications, e.g., vDU, vCU-CP, vCU-UP, and the network node 16, e.g., physical radio unit, may be independent but may also be consolidated over the same orchestrator with the same k8s API interface;
Re-use of k8s jobs for network node software upgrade jobs, e.g., radio software upgrade jobs, but applied in a new way, e.g., via RSUJEs on a network node 16 and implemented as k8s jobs that may be configured to not perform actual jobs. RSUJEs on a network node 16 may be used to request any one of a creation, a start, a stop, and a deletion of actual internal jobs running inside an RSUJEs on the same or another network node 16;
Any one of a RSUJC and a RSUJE may be deployed anywhere in the network, e.g., on a network node 16 located anywhere on the network, and is not required to be co-located;
An RSUJE, e.g., on a network node 16, can manage software for one or more than one network node 16, e.g., thousands of radio units;
RSUJCs on a network node 16 are small and moveable entities that may be instantiated and deleted without impacting the RSUJC and helm release revisions;
Multiple RSUJCs may run concurrently, e.g., on the same network node 16 or different network nodes 16, and be simultaneously supported by each RSUJE instance;
A software upgrade job can target a specific network node 16, e.g., radio unit, or a collection of network nodes, e.g., radio units, which enables for canary upgrade and flexible network node software management domains, e.g., radio unit software management domains;
Software upgrade jobs may use a matching criterion for selecting the network nodes 16, e.g., radio units.
A user or orchestrator may stop and resume a long running upgrade job potentially impacting many network nodes 16, e.g., radio units.
Service interruption during software upgrade is reduced; and
Software delivery units, e.g., CSARs, for network noes 16, e.g., radio units, are smaller and faster to transfer than typical archives.

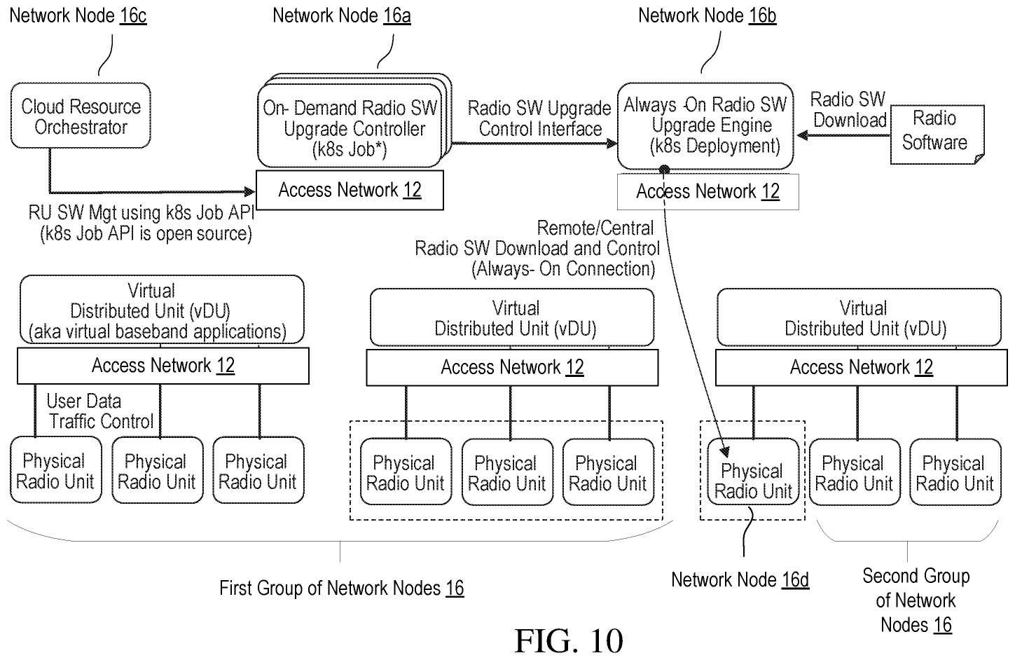

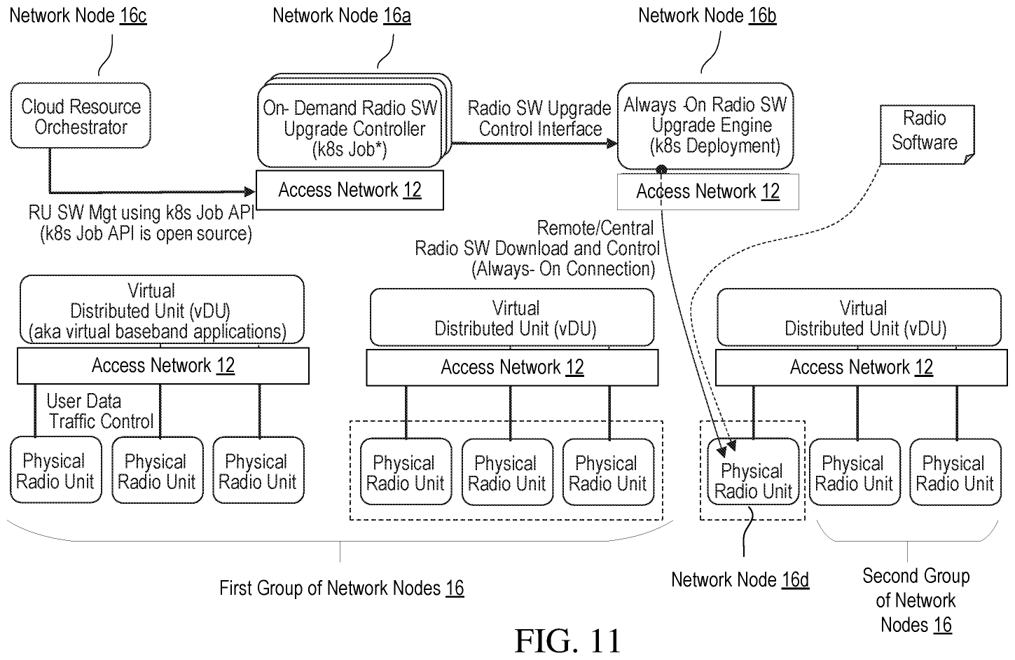

FIGS. 10 and 11 show similar embodiments of the present disclosure, e.g., software download to a network node 16, except for how network node software, e.g., radio software, is downloaded to the network node 16, e.g., radio unit. FIG. 10 shows network node software, e.g., radio software, being downloaded indirectly to network node 16d, e.g., a physical radio unit, via network node 16b, e.g., a RSUJE. Network node 16b, the RSUJE, may also download network node software to any other network node 16 of the first group of network nodes 16 and/or the second group of network nodes 16. FIG. 11 shows network node software, e.g., radio software, being downloaded directly to network node 16d, e.g., a physical radio unit. An example of direct download may be provided from a file server, e.g., any network node 16 performing a process associated with a file server. Any network node 16 (e.g., RSUJC such as an on-demand RSUJC, RSUJE such as an always-on RSUJE, management system (e.g., including an orchestrator such as a cloud resource orchestrator), file server, etc.) may be co-located in a network (e.g., located in the same network, cluster) such as access network 12 and/or core network 14. Further, any network node 16 (e.g., RSUJC such as an on-demand RSUJC, RSUJE such as an always-on RSUJE, management system (e.g., including an orchestrator such as a cloud resource orchestrator), file server, etc.) may be located in a network that is different from the network where at least one other network node 16 is located, e.g., not co-located. In one nonlimiting example, at least one network node 16 of the first group of network nodes 16 (e.g., physical radio units) may be co-located (co-located in the same access network node 12) with another network node 16 of the first group of network nodes 16 and/or be in a different network than the network (e.g., another access network 12) of another network node 16 of the second group of network nodes 16 (e.g., physical radio units). In another nonlimiting example, any one of network node 16a, 16b, 16c may be in the same access network 12 or different access network 12. In some embodiments, network node 16 supports virtualization, e.g., network nodes 16a, 16b, 16c may be virtualized, and network node 16d is a physical radio unit. In other words, network node 16 may be configured a virtual network node and/or a physical network node.

### Orchestration

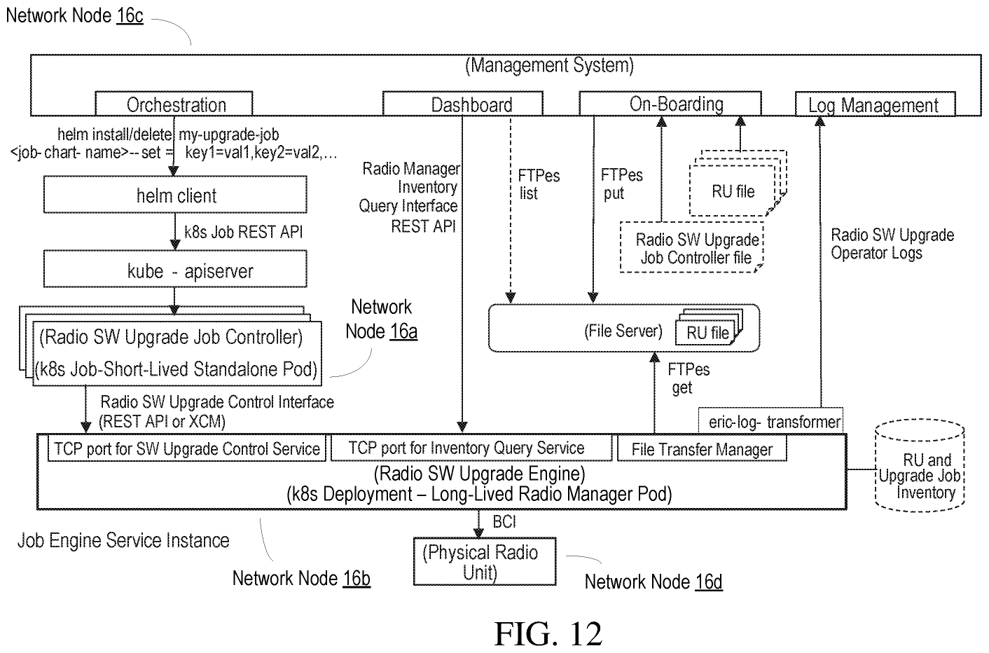

An orchestrator, e.g., a cloud orchestrator, provides management, such as via a user interface, of RSUJCs which may be associated with a vendor-provider. Management of RSUJCs may be provided using Helm and/or k8s API. RSUJCs may be realized as k8s Jobs or k8s Deployments. Four nonlimiting examples of orchestration options, e.g., helm-based options, are as follows.
Option A: an RSUJC is realized as a “short-lived” k8s Job that is packaged in its own, separate, CSAR and does not run in an RSUJE, e.g., the RSUCJC and the RSUJE are part of different network nodes 16.
Option B: an RSUJC is realized as a “long-lived” k8s Deployment that is packaged in its own, separate, CSAR and does not run in an RSUJE, e.g., the RSUCJC and the RSUJE are part of different network nodes 16.
Option C: an RSUJC is realized as a “short-lived” k8s Job that is packaged with a CSAR associated with an RSUJE and runs inside the RSUJE, e.g., the RSUCJC and the RSUJE are part of the same network node 16.
Option D: an RSUJC is realized as a “long-lived” k8s Deployment that is packaged with a CSAR associated with an RSUJE and runs inside the RSUJE, e.g., the RSUCJC and the RSUJE are part of the same network node 16.
   FIG. 12 is a diagram of an example RSUJC realized as a k8s Job according to Option A. Network node 16a has instantiated at least an RSUJC. Network node 16b has deployed an RSUJE. The RSUJC is packaged in its own, separate, CSAR and does not run in the RSUJE. Communication between Network nodes 16a and 16b may be interfaced by a RSUCI. Network node 16c is a management system and may be configured to provide orchestration, dashboard visualization, on-boarding, and log management. Network node 16d is a physical radio unit, which may receive and perform a software update. Any one of the RU file, Radio SW Upgrade Job Controller file, RU file may be any kind of file. In one nonlimiting example, the RU file may be RU software such as an RU software package and/or the Radio SW Upgrade Job Controller file may be a Radio SW Upgrade Job Controller CSAR and/or the RU file may be an RU software package, an RU CSAR, etc. Further, although FTPes list and FTPes put are shown from network node 16c to the file server (e.g., another network node 16), network node 16c and/or the file server are limited as such and may refer to any protocol process step such as any file transfer protocol (FTP) step such as FTP/FTPes/SFTP.

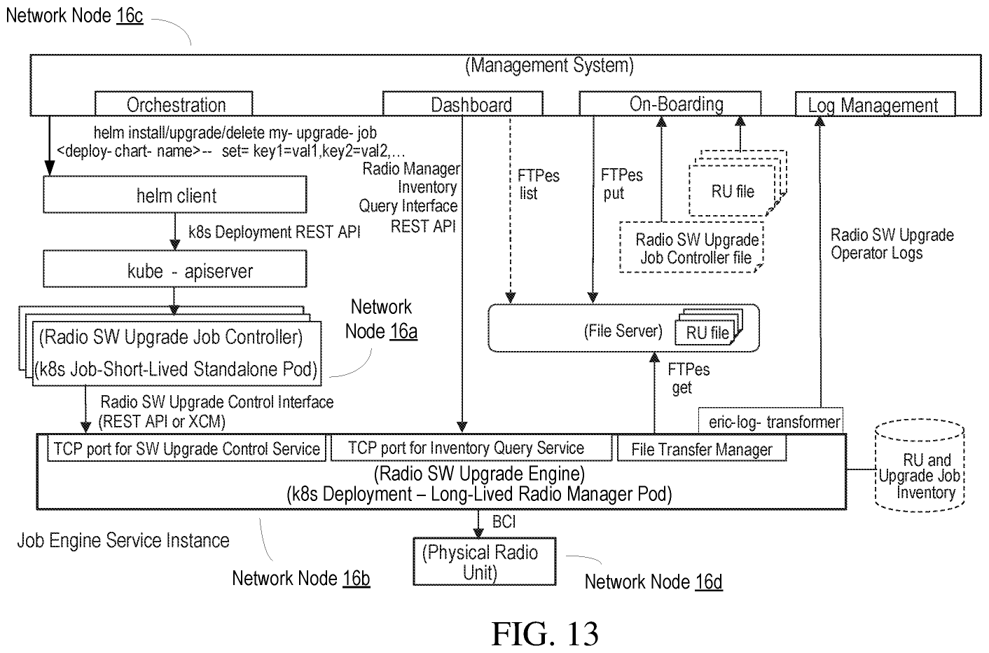

FIG. 13 is a diagram of an example RSUJC realized as a k8s Deployment according to Option B. Network node 16a has instantiated at least an RSUJC. Network node 16b has deployed an RSUJE. The RSUJC is packaged in its own, separate, CSAR and does not run in the RSUJE. Communication between Network nodes 16a and 16b may be interfaced by a RSUCI. Network node 16c is a management system and may be configured to provide orchestration, dashboard visualization, on-boarding, and log management. Network node 16d is a physical radio unit, which may receive and perform a software update.

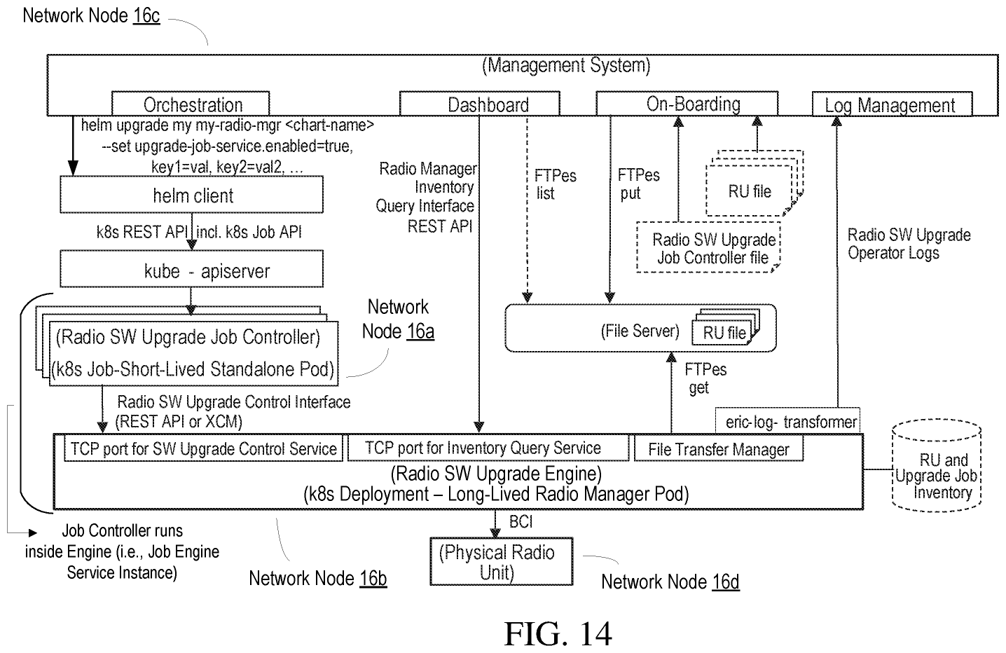

FIG. 14 is a diagram of an example RSUJC realized as a k8s Job according to Option C. Network node 16a has instantiated at least an RSUJC. Network node 16b has deployed an RSUJE. The RSUJC is packaged with a CSAR associated with the RSUJE and runs inside the RSUJE. Communication between Network nodes 16a and 16b may be interfaced by a RSUCI. Network node 16c is a management system and may be configured to provide orchestration, dashboard visualization, on-boarding, and log management. Network node 16d is a physical radio unit, which may receive and perform a software update.

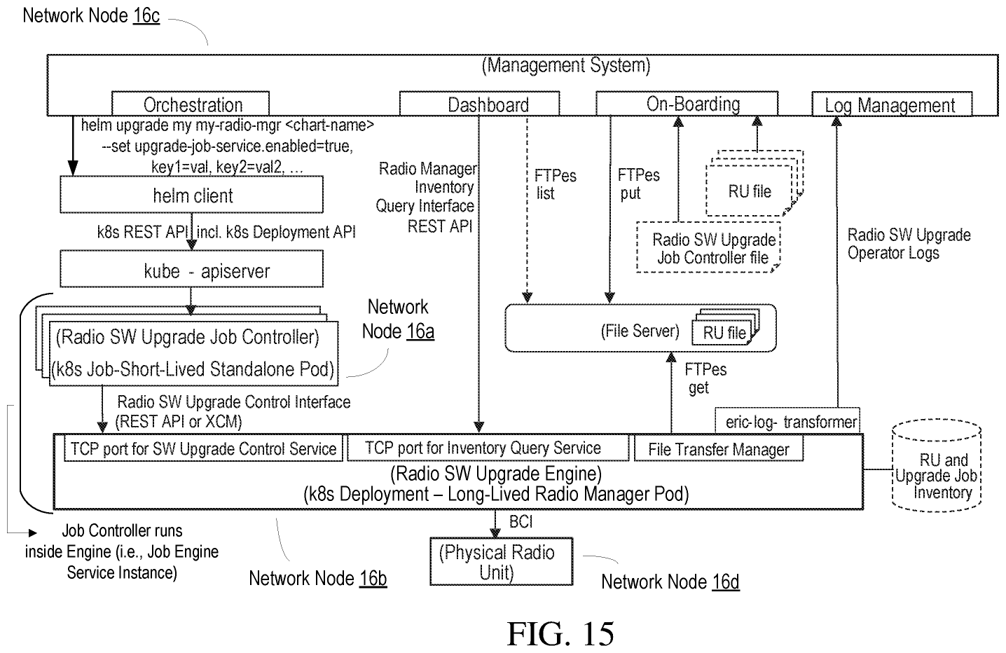

FIG. 15 is a diagram of an example RSUJC realized as a k8s Deployment according to Option D. Network node 16a has instantiated at least an RSUJC. Network node 16b has deployed an RSUJE. The RSUJC is packaged with a CSAR associated with the RSUJE and runs inside the RSUJE. Communication between Network nodes 16a and 16b may be interfaced by a RSUCI. Network node 16c is a management system and may be configured to provide orchestration, dashboard visualization, on-boarding, and log management. Network node 16d is a physical radio unit, which may receive and perform a software update.

Option A or option B may be preferrable. Options A and B provide the following benefits over Options C and D.
RSUJCs, e.g., k8s Jobs or k8s Deployments, may be instantiated and deleted without impacting the Job Engine configuration and Helm release revisions;
RSUJCs may be easily managed and automated by any orchestrator as “cVNFs”;
RSUJCs may be standalone, small, simple, and moveable entities that may be executed anywhere in the network, such as in any network node 16, including within any network node 16 acting as a management system, shown as network node 16c in FIGS. 12-15.
Multiple RSUJCs may run concurrently and be simultaneously supported by each RSUJE instance.

Further, Option A may provide some added value over Option B as follows.
k8s Jobs may allow for triggering individual tasks related to a workflow associated with a network node software upgrade, e.g., radio software upgrade.
Each k8s Job may be associated with a specific job request type or a combination, e.g., create, start, stop, or delete, for a complete workflow associated with a network node software upgrade, e.g., radio software upgrade.
k8s Jobs provide additional job-related features, such as maximum number of retries and maximum job duration, and additional operational information, such as job events and job status, that may not be available with k8s Deployments.

Option B may be simpler than other options to implement for the orchestrator. This may be due to a reduced number of LCM operations that result from using the same k8s Deployment instance for all job requests, e.g., create, start, stop, and delete, especially when a stop request is made.

### Configurable Parameters for Radio Unit Software Upgrades

Configurable parameters that are used to perform a network node software upgrade job, e.g., a radio software upgrade job (such as using k8s Job or k8s Deployment). Configurable parameters include matching criteria for selecting network nodes 16 (e.g., the radio units), target software version, job request type, job request list of types, job action, and list of actions to perform on the selected network node 16, e.g., selected radio unit. Configurable parameters may be passed using helm values during an instantiation or update of RSUJCs, e.g., k8s Job described in Options A and C, k8s Deployment described in Options B and D. Table 1 is an example list of job configuration parameters. Job configuration parameters may include any parameter other than the parameters listed in Table 1.

TABLE 1
Nonlimiting example of job configuration parameters

| Value | Description | MVP Example |
|---|---|---|
| productName | A sequence of | Must match string exactly |
| | characters that define | Example: AAS |
| | a search pattern for | |
| | the radio product | |
| | name | |
| productNumber | A sequence of | Must match string exactly |
| | characters that define | Example: KRD 901 141/11 |
| | a search pattern for | |
| | the radio product | |
| | number | |
| productRevision | A sequence of | Exact match, >, >=, <, <=, range |
| | characters that define | Example: R1D |
| | a search pattern for | |
| | the radio product | |
| | revision | |
| serialNumber | A sequence of | Must match string exactly |
| | characters that define | Single value or list |
| | a search pattern for | Example: A40003L9N9, |
| | the radio unit serial | A081648612 |
| | number | |
| swProductNumber | The desired software | Must match string exactly |
| | product number | Example: CXP202017_1 |
| swProductVersion | The desired software | Exact match or “latest” or |
| | product version | “previous” |
| | | Example: latest, previous |
| swUri | The URI (path) for | Exact Match |
| | the desired software | ftp://ftp.file.server:999/foo/bar.bin. |
| | product number and | |
| | version | |
| jobRadioActions | The actions | List |
| | performed on the | Example: loadSw, |
| | radio units the job is | activateSwPreCheck, activateSw, |
| | active/started | activateSwPostCheck |
| | (mandatory) | |
| | List of | |
| | loadSwPreCheck, | |
| | loadSw, | |
| | activateSwPreCheck, | |
| | activateSw, | |
| | activateSwPostCheck | |
| jobReqTypes | The job request types | List |
| | (mandatory) | Example: create, start |
| | List of create, start, | |
| | stop or delete | |
| jobId | The unique job | List |
| | identifier generated | |
| | by the Radio | |
| | Software Upgrade | |
| | Engine (optional) | |
| | Note: Only | |
| | applicable when Job | |
| | Controller is a k8s | |
| | Job | |

An example of a user-initiated RSUJCs, e.g., a k8s Job, that requests a creation and a start of an internal job intended to check, download, and activate a specific network node software version, e.g., radio software version onto two specific network nodes 16, specific radio units, based on serial numbers associated with the network nodes 16, e.g., specific radio units.
api Version: apps/v1
kind: Job
metadata:
name: my-upgrade-job-radio-sw-controller
labels:
   app.kubernetes.io/name: radio-sw-controller
   app.kubernetes.io/instance: my-upgrade-job
spec:
   parallelism: 1
   backoffLimit: 1
   activeDeadlineSeconds: 3600
   template:
      spec:
         containers:
         name: radio-sw-controller
         image: “proj-exilis-drop/eric-ran-radio-sw-upgrade-controller: 1.31”
         env:
         name: SERIAL_NUMBER
         value: “A40003L9N9, A081648612”
         name: SW_PRODUCT_NUMBER
         value: “CXP202017_1”
         name: SW_PRODUCT_VERSION
         value: “latest”
         name: JOB_RADIO_ACTIONS
         value: “loadSwPreCheck, loadSw, activateSwPreCheck,
         activateSw, activateSwPostCheck”
         name: JOB_REQ_TYPE
         value: “create,start”
         resources:
         requests:
         cpu: 50 m
         memory: 100 Mi
      restartPolicy: OnFailure

In this example, the job configuration data is passed to a k8s Job as container environment variables. The configuration data may also be passed to the k8s Job using other k8s run-time configurations methods such as container arguments, ConfigMap data, or a combination of container environment variables with ConfigMap data. However, passing configuration data is not limited to the described methods and may be any method.

With respect to job requests, the following is nonlimiting list of job request types:
Create, which creates a new job record within an inventory;
Start, which starts the job within an RSUJE, so that the job is active inside the RSUJE;
Stop, which stops the job within the RSUJE, so that the job is inactive in the RSUJE; and
Delete, which deletes the job from the RSUJE and removes the corresponding record from the inventory.

Instantiating a RSUJCs, e.g., k8s Job or k8s Deployment, with jobRequestType={create, start} automatically creates a new job and then starts the new job. Instantiating a RSUJCs with jobRequestType={create, start, delete} automatically creates a new job, starts the new job, and then deletes the new job upon completion.

A manual rollback can be achieved in different ways. For example, an operator may stop or delete a job anytime. Then, another job may be created and started which rolls back one or more network nodes 16, e.g., radio units, to a previous software version.

### Inventory for Upgrade Jobs and Radio Units

An RSUJE may include a database, e.g., local on-disk or remote on-disk database, for storing records/data of software upgrade jobs that have been deployed by users as well hardware and software information about each network node 16, e.g., radio unit, managed by the RSUJE. The RSUJE stores the data in a predetermined format, e.g., custom format, in a predetermined storage location, e.g., local storage, persistent volume. The database may be referred to as a Radio Unit and Upgrade Job Inventory (RUUJI). The RUUJI holds records about upgrade jobs and network nodes 16, e.g., radio units. In some embodiments, the RUUJI It does not permanently store radio software files but includes a location where a file may be retrieved from. In a nonlimiting example, a file location may be in another network node 16, e.g., a secured file server. The file location is specified using a Uniform Resource Identifier (URI). An example of a URI is [FEDC:BA98:7654:3210:FEDC:BA98:7654:3210]:999/foo/bar.bin.

During the process of upgrading the software of a network node 16, e.g., a radio unit, the RSUJE fetches a software file, e.g., radio software file, from another network node 16, e.g., a file server, and may temporarily keep a copy in its local storage. When the upgrade job, i.e., a job record, is deleted from the database, e.g., the RUUJI, the radio software file is also deleted from local storage.

There are different ways to clean up upgrade job records. A user-configurable retention time, which may be specified in a predetermined amount of time, is an example of one way to automatically delete old job records. A Radio SW Upgrade Control Interface (RSUCI) may also provide a process for a user to automatically delete a job at the end of an upgrade procedure or to delete multiple jobs at the same time.

The following data is a nonlimiting example of data that may be stored in each job record. The job records are indexed or identified using job fingerprints generated by the RSUJE. The job fingerprint is a hash on the job configurable values, e.g., environment variables related to a radio hardware and software, that uniquely identifies each job.

```
type Job struct {
  jobid string (fingerprint)
  jobname string
  jobreqtypes string
  jobstate string
  jobradioactions string
  createyear int
  createmonth int
  createday int
  createtime string
  startyear int
  startmonth int
  startday int
  starttime string
  stopyear int
  stopmonth int
  stopday int
  stoptime string
  productname string
  productnumber string
  productrevision string
  serialnumber string
  swproductnumber string
  swproductversion string
  swuri string
  lastevent string
  matchingruids string
}
```

The RSUJE may communicate with each network node 16, e.g., radio units, and populate the inventory with radio unit product data, e.g., product name, product number, product revision, serial number, as well as current and past radio software versions loaded in each radio unit. The following data is an example of data that may be stored in each radio unit record.

```
type RadioUnit struct {
  ruid string (serialnumber)
  ruip string
  productname string
  productnumber string
  productrevision string
  serialnumber string
  compatibilitylist string
  currentswproductnumber string
  currentswproductversion string
  currentswactivateyear string
  currentswactivatemonth string
  currentswactivateday string
  currentswactivatetime string
  currentswstoreyear string
  currentswstoremonth string
  currentswstoreday string
  currentswstoretime string
  currentswuri string
  other1swproductnumber string
  other1swproductversion string
  other1swdeactiveyear string
  other1swdeactivatemonth string
  other1swdeactivateday string
  other1swdeactivatetime string
  other1swstoreyear string
  other1swstoremonth string
  other1swstoreday string
  other1swstoretime string
  other1swuri string
  other2swproductnumber string
  other2swproductversion string
  other2swdeactiveyear string
  other2swdeactivatemonth string
  other2swdeactivateday string
  other2swdeactivatetime string
  other2swstoreyear string
  other2swstoremonth string
  other2swstoreday string
  other2swstoretime string
  other2swuri string
}
```

A RUUJI may provide any one of the following usages:
The RUUJI may allow the RSUJE to expose a simple query REST API interface, e.g., read only, that may be consumed by any cloud dashboards for visualizing content of the inventory, such as the progress of network node software upgrade jobs, e.g., radio software upgrade jobs, in real-time as well as monitoring network nodes 16 managed by the RSUJE along with current and available radio software versions.
The RUUJI may allow the RSUJE to automatically upgrade a network node 16, e.g., radio unit, that is running a particular boot image, e.g., a basic vanilla boot image. An example of the particular boot image may include when a network node 16 is in a predetermined state, e.g., a radio unit is turned on, turned off and then turn back on again, crashed and trying to recover. In other words, the RUUJI may allow the RSUJE to automatically upgrade a network node 16 without any direct user intervention. The automatic upgrade may be based on a predetermined condition, e.g., as long as there is a software upgrade job that matches a network node 16, e.g., radio unit, with actions to load and activate available in the inventory.

### Radio SW Upgrade Control Interface

A Radio SW Upgrade Control interface (RSUCI) may be defined to perform between a pod associated with a RSUJC, e.g., k8s Job, k8s Deployment, and a pod associated with a RSUJE, e.g., k8s Deployment. The RSUCI may be implemented as a REST API or XCM interface over a predetermined connection, e.g., a Transport Layer Security (TLS) connection.

For ease of understanding, the use of XCM is assumed herein. XCM works for the most part by setting up a server socket on a RSUJE that RSUJE client(s) can then connect to. Once a connection TCP connection, e.g., a Transmission Control Protocol (TCP) connection over TLS, has been established both the server and the client(s) can send messages to each other.

The RSUCI allows the client to create, start, stop, and delete radio software upgrade jobs and allows the server to report job state changes and network node software changes, e.g., radio unit software changes, including error conditions using notifications, e.g., asynchronous notifications. Asynchronous heartbeat notifications may also be sent by either the client or the server or by both sides simultaneously. A configurable keep-alive interval and timeout allows the client and/or the server to supervise connectivity. The RSUJE may decide to put an active job on hold or stop the active job if the pod associated with the RSUJC disappears or is no longer reachable.

The RSUJC pod can be deployed using a k8s Job or k8s Deployment. Each RSUJC communicates a start of a specific job with information to complete the job, such as matching criteria for selecting network nodes 16 (e.g., radio units), target software version, request types and upgrade actions. The RSUJC may also log client-side information about the job and the impacted network nodes 16, e.g., radio units. For Option A and Option B, each RSUJC is deployed, inspected, and deleted independently from the RSUJE.

The RSUJE may provide vendor software upgrade logic and execute requested jobs based on instructions provided by the RSUJC. The RSUJE may keep a record of each job including completed jobs. Records in the RSUJE may be explicitly deleted by the user. Further the RSUJE may log server-side information about a job and impacted network nodes 16, e.g., radio units. Further, the RSUJE may be configured to be continuously present in the network and may communicate, directly or indirectly, with network nodes 16, e.g., radio units and at least another network node 16, e.g., a secured File Server, where network node software is stored.

The following messages are examples of a XCM service definition for a RSUCI:

```
XCM Service Definition for Radio SW Upgrade Control Interface
service:
  name: RadioUpgradeControlService
  properties: [ ]
protocol:
  # TODO Use a real id.
  id: 0xffff
  header:
    fields:
      - name: message_code
        size: 16
        type: enum
  messages:
    - name: CreateRadioUpgradeJobReq
      refs:
        - message_code: 0x0
    - name: CreateRadioUpgradeJobCfm
      refs:
        - message_code: 0x1
    - name: CreateRadioUpgradeJobRej
      refs:
        - message_code: 0x2
    - name: StartRadioUpgradeJobReq
      refs:
        - message_code: 0x3
    - name: StartRadioUpgradeJobCfm
      refs:
        - message_code: 0x4
    - name: StartRadioUpgradeJobRej
      refs:
        - message_code: 0x5
    - name: StopRadioUpgradeJobReq
      refs:
        - message_code: 0x6
    - name: StopRadioUpgradeJobCfm
      refs:
        - message_code: 0x7
    - name: StopRadioUpgradeJobRej
      refs:
        - message_code: 0x8
    - name: DeleteRadioUpgradeJobReq
      refs:
        - message_code: 0x9
    - name: DeleteRadioUpgradeJobCfm
      refs:
        - message_code: 0x10
    - name: DeleteRadioUpgradeJobRej
      refs:
        - message_code: 0x11
    - name: RadioUpgradeJobStateChangeInd
      refs:
        - message_code: 0x12
    - name: RadioUnitSoftwareChangeInd
      refs:
        - message_code: 0x13
    - name: HearbeatInd
      refs:
        - message_code: 0x14
```

Further, a RSUCI may map operations and signals. Table 2 shows an example mapping between LCM operations and signals on RSUCI when RSUJC is a k8s Job.

TABLE 2
k8s Job LCM and RSUJC signals

| Job | LCM | Job Control |
|---|---|---|
| Procedure | Command | Messages |
| Create a | helm install my-create-upgrade- | CreateRadioUpgradeJobReq |
| new | job | (key1=val1,...) |
| upgrade | <job-chart-name> --set= | CreateRadioUpgradeJobCfm |
| job using a | jobReqType=create,key1=val1,... | (jobId=abc) |
| new k8s | | RadioUpgradeJobStateChangeInd |
| Job | | (CONFIRM_COMPLETED) |
| instance | | |
| Inspect | kubectl describe jobs/my-create- | No Signal |
| and | upgrade-job | |
| Cleanup | helm delete my-create-upgrade- | |
| Succeeded | job | |
| Create k8s | | |
| Job | | |
| Instance | | |
| Start the | helm install my-start-upgrade-job | StartRadioUpgradeJobReq |
| upgrade | <job-chart-name> --set= | (jobId=abc) |
| job using a | jobReqType=start,jobId=abc) | StartRadioUpgradeJobCfm |
| new k8s | | (jobId=abc) |
| Job | | RadioUpgradeJobStateChangeInd |
| instance | | (CONFIRM_COMPLETED) |
| Inspect | kubectl describe jobs/my-start- | No Signal |
| and | upgrade-job | |
| Cleanup | helm delete my-start-upgrade-job | |
| Succeeded | | |
| Start k8s | | |
| Job | | |
| Instance | | |
| Stop the | helm install my-stop-upgrade-job | StopRadioUpgradeJobReq |
| upgrade | <job-chart-name> --set= | (jobId=abc) |
| job using a | jobReqType=stop,jobId=abc) | StopRadioUpgradeJobCfm |
| new k8s | | (jobId=abc) |
| Job | | RadioUpgradeJobStateChangeInd |
| instance | | (CONFIRM_COMPLETED) |
| Inspect | kubectl describe jobs/my-stop- | No Signal |
| and | upgrade-job | |
| Cleanup | helm delete my-stop-upgrade-job | |
| Succeeded | | |
| Stop k8s | | |
| Job | | |
| Instance | | |
| Delete the | helm install my-delete-upgrade- | DeleteRadioUpgradeJobReq |
| upgrade | job | (jobId=abc) |
| job using a | <job-chart-name> --set= | DeleteRadioUpgradeJobCfm |
| new k8s | jobReqType=delete,jobId=abc) | (jobId=abc) |
| Job | | RadioUpgradeJobStateChangeInd |
| instance | | (CONFIRM_COMPLETED) |
| Inspect | kubectl describe jobs/my-delete- | No Signal |
| and | upgrade-job | |
| Cleanup | helm delete my-delete-upgrade- | |
| Succeeded | job | |
| Delete k8s | | |
| Job | | |
| Instance | | |

Table 3 shows an example mapping between LCM operations and RSUJC signals when the RSUJC is a ke8 Deployment.

TABLE 3
k8s Deploy LCM and RSUJC signals

| Job | | |
|---|---|---|
| Procedure | LCM Command | Job Control Messages |
| Create a | helm install my-upgrade-job | CreateRadioUpgradeJobReq |
| new | <deploy-chart-name> --set= | (key1=val1,...) |
| upgrade job | jobReqType=create,key1=val1,... | CreateRadioUpgradeJobCfm |
| using a | | (jobId=abc) |
| new k8s | | RadioUpgradeJobStateChangeInd |
| Deployment | | (CONFIRM_COMPLETED) |
| instance | | |
| Start the | helm upgrade my-upgrade-job | StartRadioUpgradeJobReq |
| upgrade job | <deploy-chart-name> --set= | (jobId=abc) |
| by updating | jobReqType=start) | StartRadioUpgradeJobCfm |
| the existing | | (jobId=abc) |
| k8s | | RadioUpgradeJobStateChangeInd |
| Deployment | | (CONFIRM_COMPLETED) |
| instance | | |
| Stop the | helm upgrade my-upgrade-job | StopRadioUpgradeJobReq |
| upgrade job | <deploy-chart-name> --set= | (jobId=abc) |
| by updating | jobReqType=stop) | StopRadioUpgradeJobCfm |
| the existing | | (jobId=abc) |
| k8s | | RadioUpgradeJobStateChangeInd |
| Deployment | | (CONFIRM_COMPLETED) |
| instance | | |
| Delete the | helm upgrade my-upgrade-job | DeleteRadioUpgradeJobReq |
| upgrade job | <deploy-chart-name> --set= | (jobId=abc) |
| by updating | jobReqType=delete) | DeleteRadioUpgradeJobCfm |
| the existing | | (jobId=abc) |
| k8s | | RadioUpgradeJobStateChangeInd |
| Deployment | | (CONFIRM_COMPLETED) |
| instance | | |
| Delete the | helm delete my-upgrade- | No Signal |
| k8s | upgrade-job | |
| Deployment | | |
| instance | | |

A number of k8s Jobs may also be reduced. For instance, instantiating a single RSUJC as a k8s Job with jobRequestType={create, start, delete} automatically creates a new job, starts the new job, and then deletes the new job upon completion.

### Radio Software CSAR

A CSAR is a cloud-based archive which, in the case of network node software, e.g., radio software CSAR, may include one or more Load Module Containers (LMCs) for a network node type or network node product name. A CSAR may also contain network node radio but does not require any helm charts nor docker images. In addition, a CSAR may include additional information to help with design of run-time job configuration parameters for a RSUJC. The additional information may include hardware and software compatibility list as well as any possible dependencies with other Cloud RAN components.

### Radio Software Upgrade Job Controller CSAR

Options A and B described above, may be implemented using an RSUJC CSAR. An RSUJC CSAR may include a helm chart and docker image(s) associated with an RSUJC. More specifically, an RSUJC CSAR may provide a template associated with a k8s Job and/or with a k8s Deployment for instantiating and managing a RSUJC outside an RSUJE.

### Cloud-Based Radio Unit Software Management Use Cases

Use cases associated with network node software management, e.g., physical radio unit software management, based on option A may include any of the following:
Network node inventory, e.g., radio unit inventory, retrieval by a Cloud Dashboard
Software upgrade job inventory retrieval by Cloud Dashboard;
Network node software metadata retrieval by Cloud Dashboard;
User-defined software loading precheck using a k8s Job instance;
User-defined software loading and activation using a k8s Job instance; and
System-triggered software loading and activation for unit in boot image.

### Network Node Inventory Retrieval by Cloud Dashboard

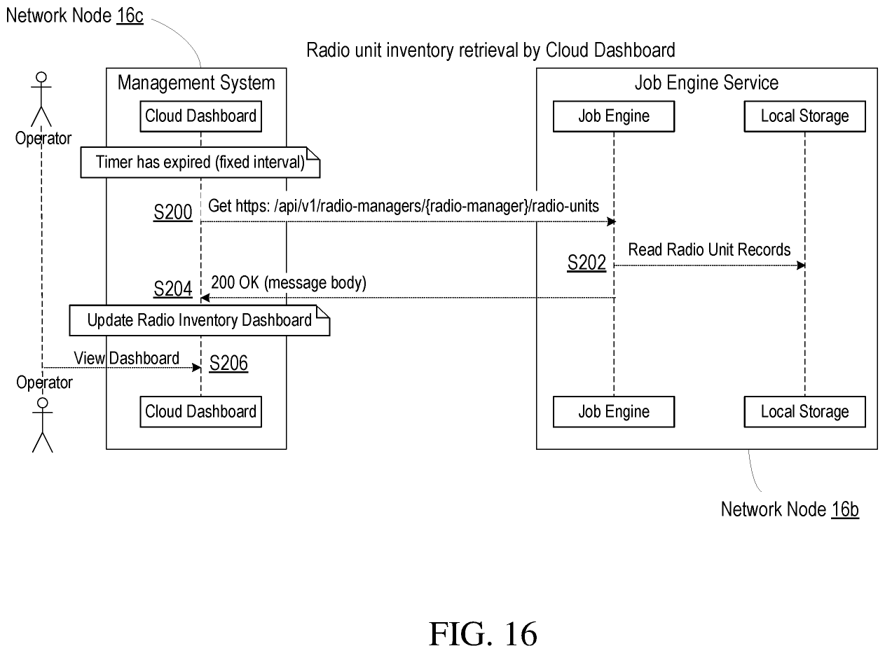

FIG. 16 shows an example call sequence to automatically visualize a network node inventory, e.g., radio unit records, in real-time on a cloud dashboard including network node product data, IP address, as well as current and past radio software versions loaded in each network node 16, e.g., radio unit.

At step S200, network node 16c, e.g., a management system, including a cloud dashboard, sends a request to retrieve network node inventory to network node 16b, e.g., a RSUJE, which, at step S202, reads from storage records associated with the network node inventory retrieval. At step S204, a message response is transmitted back to the network node 16c, and at step S206, a user/operator may view the results of the retrieval request on the cloud dashboard of the network node 16c.

### Upgrade Job Inventory Retrieval by Cloud Dashboard

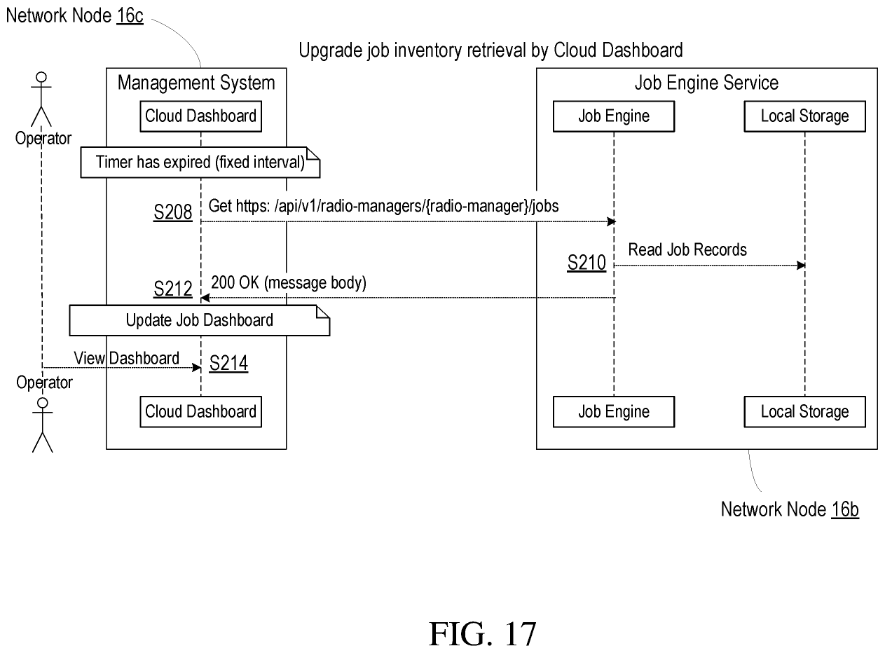

FIG. 17 shows an example call sequence to automatically visualize upgrade job inventory, such as job records, in real-time on a cloud dashboard including upgrade job description and status.

At step S208, network node 16c, e.g., a management system, including a cloud dashboard, sends a request to retrieve upgrade job inventory to network node 16b, e.g., a RSUJE, which, at step S210, reads, from storage, records associated with upgrade job inventory. At step S212, a message response is transmitted back to the network node 16c, and at step S214, a user/operator may view the results of the retrieval request on the cloud dashboard of the network node 16c.

### Network Node Software Metadata Retrieval by Cloud Dashboard

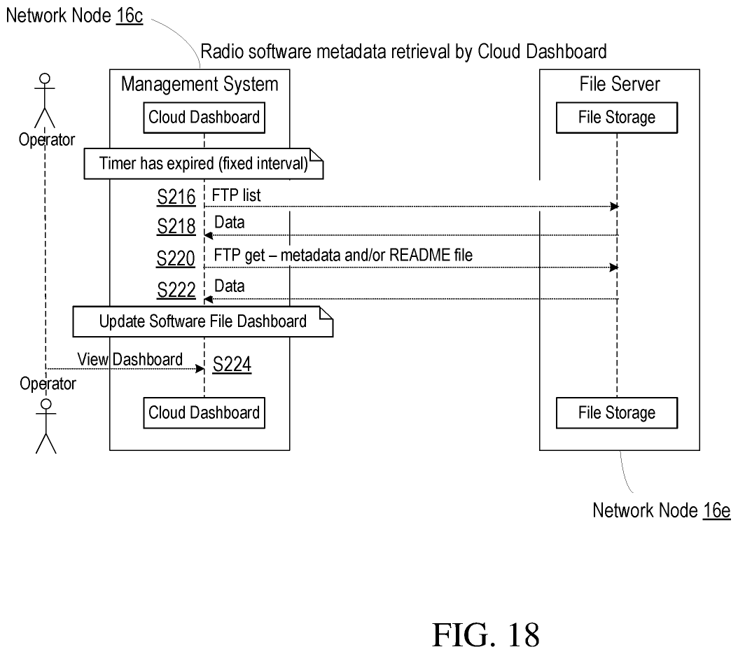

FIG. 18 shows an example call sequence to automatically visualize content of a network node software repository, e.g., radio LMCs, on a cloud dashboard including file names and content of metadata Extensible Markup Language (XML) or README file.

At step S216, network node 16c, e.g., a management system, including a cloud dashboard, sends a request to retrieve a list, e.g., a File Transfer Protocol (FTP) list, to network node 16e, e.g., a file server. At step, S218, network node 16c receives data from the network node 16e. At step S220, sends another request to get meta data and/or a README file. At step, S222, network node 16c receives data from the network node 16e in response to the request sent at S220. At step S224, the operator may visualize the content of the network node repository.

### User-Defined Software Loading Precheck Using a k8s Job Instance

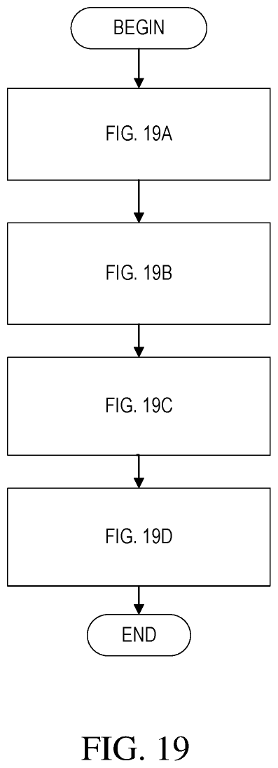

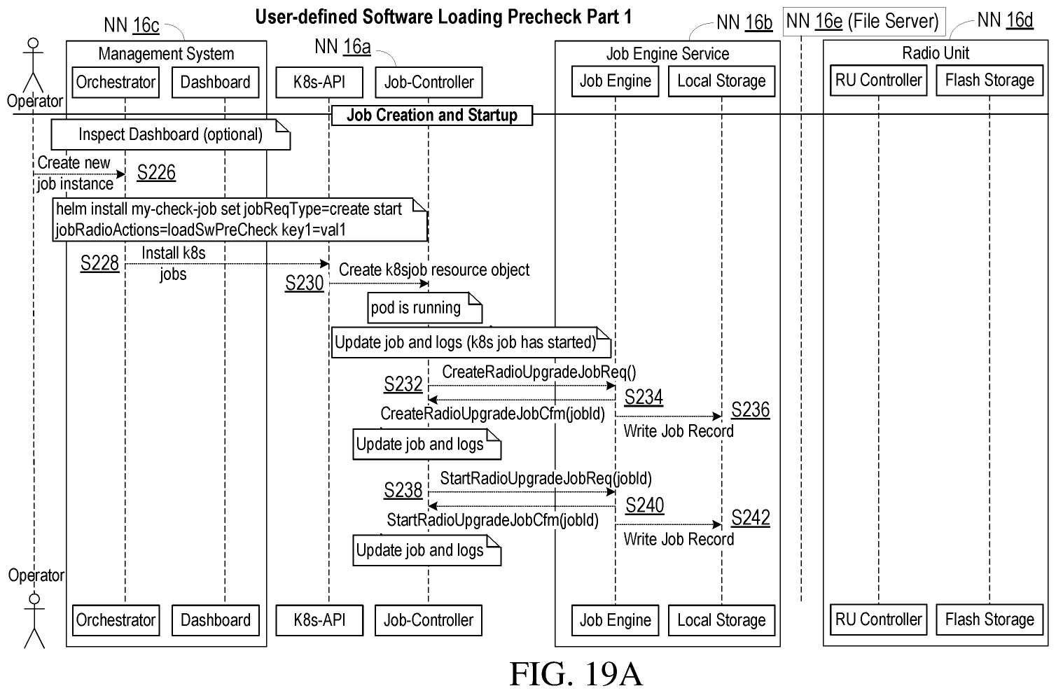

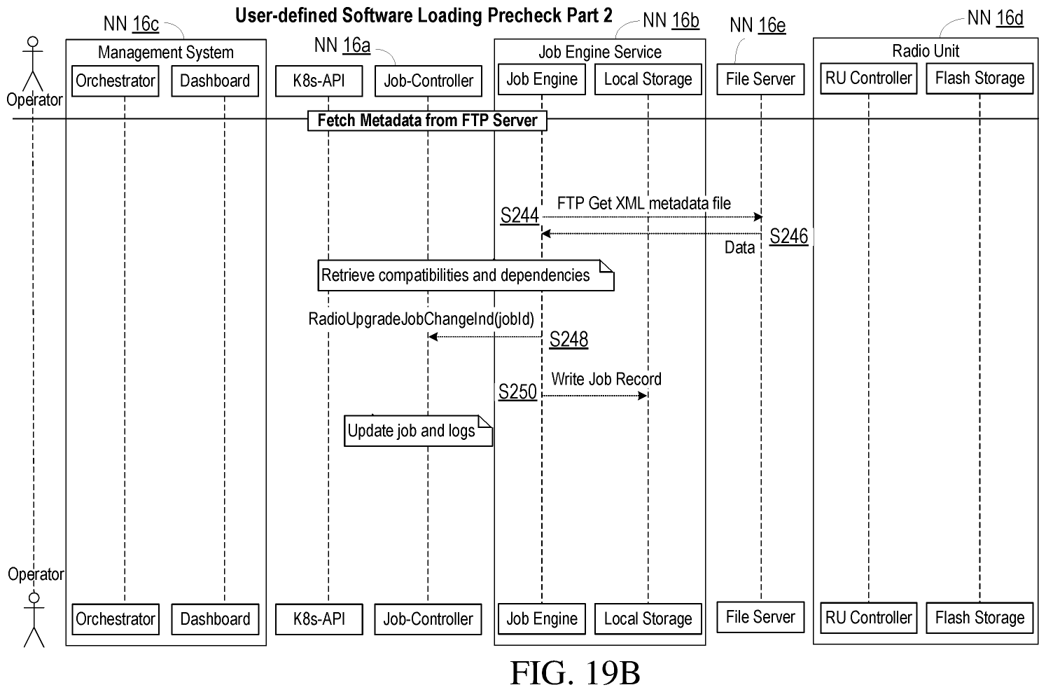

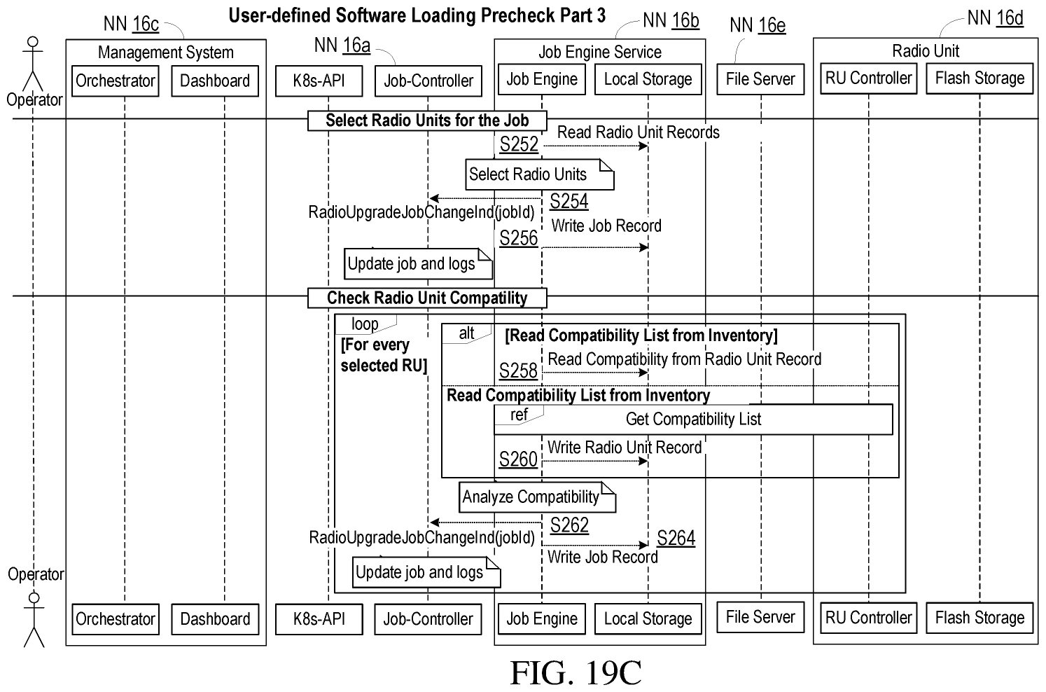

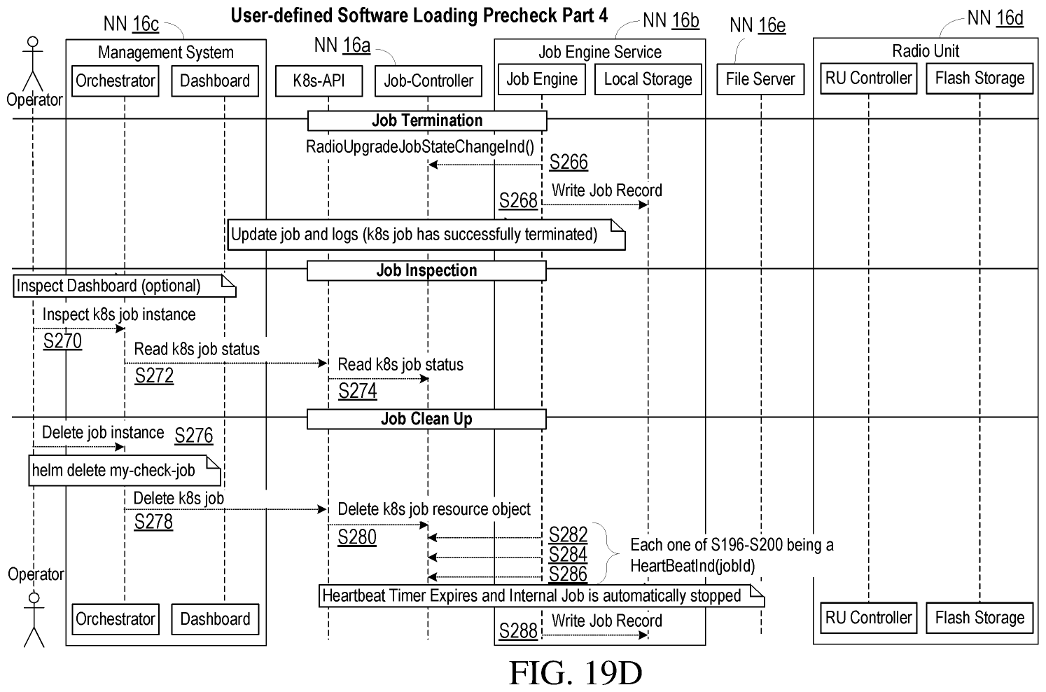

FIG. 19 is an overview of an example process of FIGS. 19A-19D according to some embodiments of the present disclosure. FIGS. 19A-19D show an example process of a user-defined software loading precheck using a k8s Job instance. More specifically, the example process includes steps for an operator to perform a precheck on the system such as before downloading and/or activating any new software on network nodes 16, e.g., radio units. This use case is intended to verify software compatibility between requested software version and the network nodes 16, e.g., the radio units.

More specifically, FIG. 19A shows an example process of job creation at startup. At step S226, the operator may create a new job instance on network node 16c, e.g., a management system, via an orchestrator, which, at step S228 sends a request to install a k8s job, e.g., sent to a k8s-API. At step S230, a request to create a k8s job resource objects is sent to network node 16a, e.g., an RSUJC. After step S230, the corresponding pod is running and a process to update the k8s job and logs is performed. At step S232, network node 16a, e.g., a RSUJC, sends a request to network node 16b, e.g., an RSUJE, to create a network node upgrade job request, and, at step S234, the request of S232 is confirmed. At S236, the network node 16b writes a job record, e.g., to local storage. At step S238, a request to start the network node upgrade job is sent from network node 16a, e.g., RSUJC, to network node 16b, e.g., the RSUJE, which is confirmed at step S240. At step S242, network node 16b, e.g., the RSUJE, writes a job record to local storage. Step S242 (and/or any other steps) may be followed by S244 (and/or any other steps) in FIG. 19B.

FIG. 19B shows an example process of fetching data from a server. At step S244, network node 16b, e.g., the RSUJE, sends a request, e.g., an FTP request to get XML metadata, to network node 16e, e.g., a file server, which replies which the requested metadata at step S246. A process to retrieve compatibilities and dependencies starts. At step S248, network node 16b sends a request, e.g., RadioUpgradeJobChangeInd(jobId), to network node 16a, the RSUJC, and writes a job record at S250. Step S250 (and/or any other steps) may be followed by S252 (and/or any other steps) in FIG. 19C.

FIG. 19C shows an example process of selecting network node units for the job and checking network node compatibility. At step S252, network node 16b, the RSUJE, reads records from storage and notifies network node 16a, the RSUJC, of the job change at step S254. At step S256, a job record is written to storage. Network node 16a updates the job and logs. A loop is started, and, at step S258, network node 16b may read a compatibility list from network node records, e.g., radio unit records. At step S260, a network node record may be written and compatibility analyzed. At step S262, a job change is sent to network node 16a, e.g., the RSUJC, which updates the job and logs. At step S264, network node 16b, the RSUJE, writes a job record. Step S264 (and/or any other steps) may be followed by S266 (and/or any other steps) in FIG. 19D.

FIG. 19D shows an example process of job termination, inspection, and cleanup. At step S266, network node 16b, e.g., the RSUJE, sends a request to update the job to network node 16a, e.g., the RSUJC, which updates the job and logs. At step S268, network node 16b writes a job record. At step S270, an operator makes a request to inspect a k8s job instance at the orchestrator of network node 16c, which makes a request to read k8s job status at step S272, e.g., via a k8s API at step S274. At step S276, the operator makes a request to delete a job instance at the orchestrator of network node 16c, which, at step S278, makes a request to delete the k8s job to the k8s-API. At step S280, the k8s-API makes a request to network node 16a, e.g., the RSUJC, to delete a k8s job resource object. At steps S282-S286, heartbeat indicators are sent from network node 16b, e.g., the RSUJE, to network node 16a, e.g., the RSUJC. After a heartbeat timer expires and the internal job is automatically stopped, at step S288, network node 16b writes a job record.

Although the overall process shown in FIG. 19 shows the process of FIG. 19A occurring first, followed by FIG. 19B, FIG. 19C, and FIG. 19D, the process is not limited as such, and the processes shown in FIGS. 19A-19D may be performed in any order. Further, one or more steps shown in FIGS. 19A-19D may be performed and/or may be performed in any order.

### User-Defined Software Loading and Activation Using a k8s Job Instance

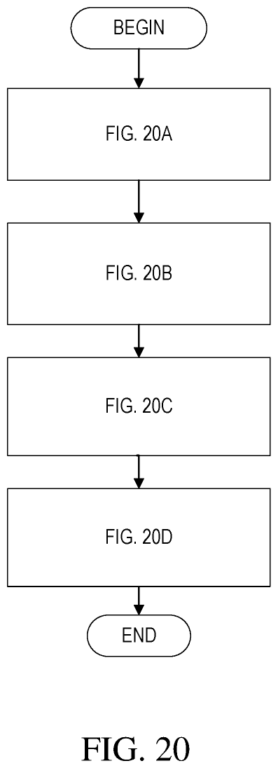

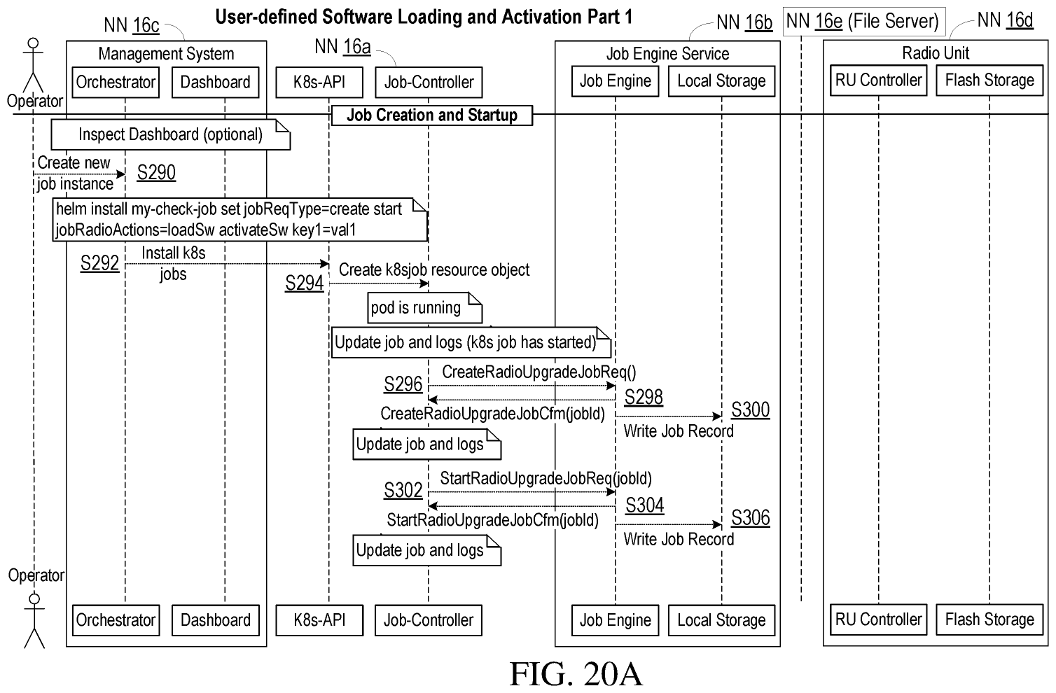

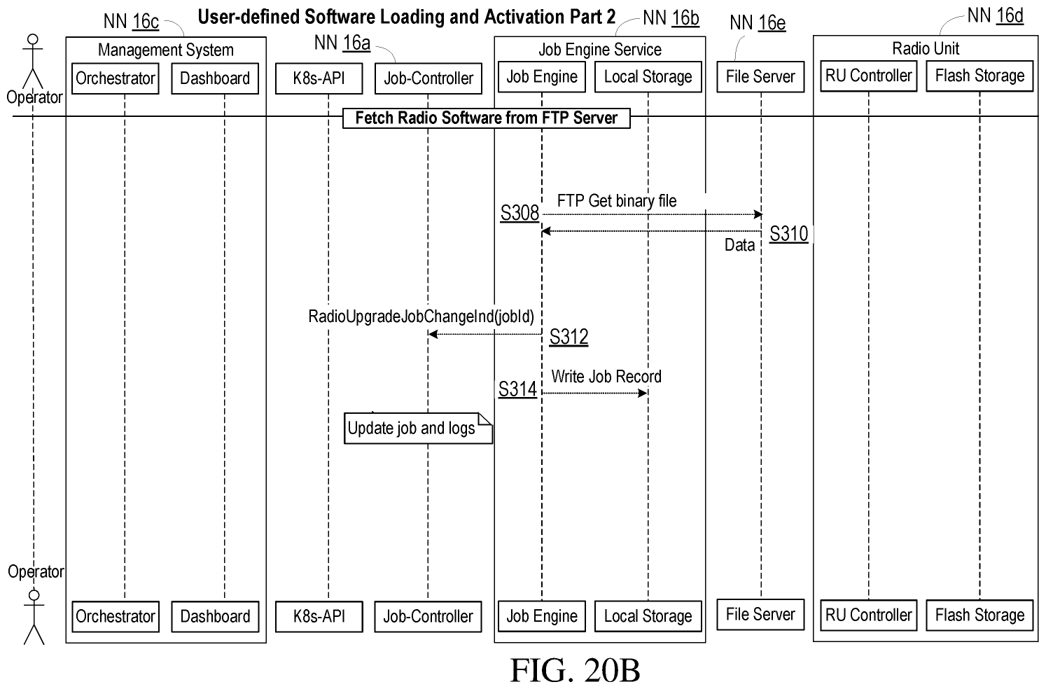

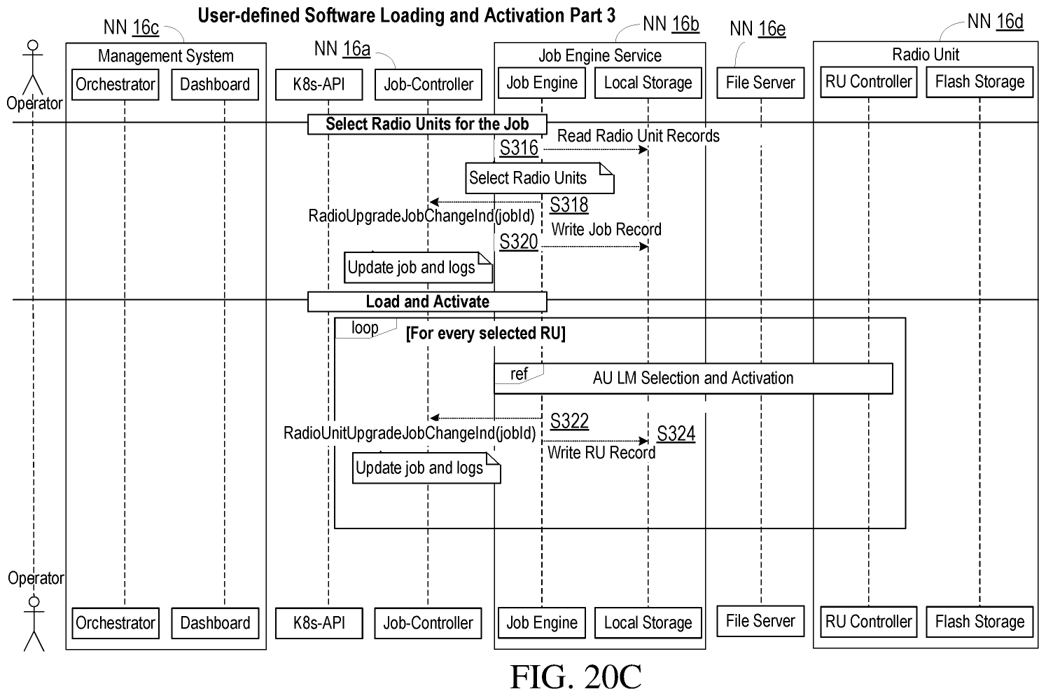

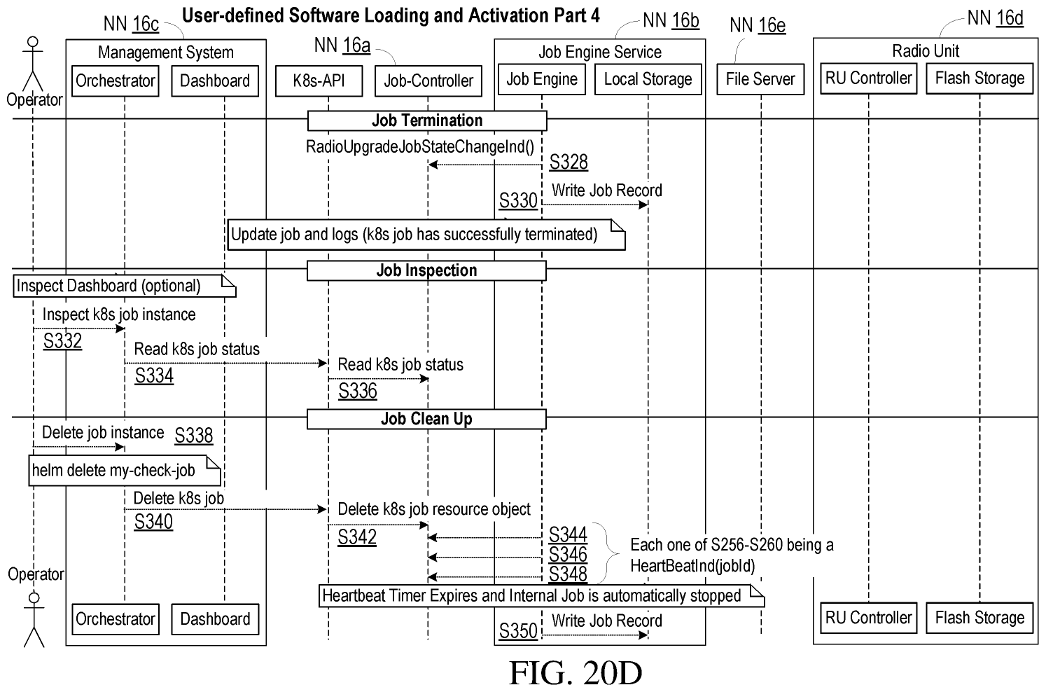

FIG. 20 is an overview of an example process of FIGS. 20A-20D according to some embodiments of the present disclosure. FIGS. 20A-20D show an example process, e.g., for an operator, to create and start an upgrade job that downloads and activates a new software version on network nodes 16, e.g., the radio units. Prior to the example process, a load software precheck job may be performed.

More specifically, FIG. 20A shows an example process of job creation and start up. At step S290, the operator may create a new job instance on network node 16c, e.g., a management system, via an orchestrator, which, at step S292 sends a request to install a k8s job, e.g., sent to a k8s-API. At step S208, a request to create a k8s job resource objects is sent to network node 16a, e.g., an RSUJC. After step S294, the corresponding pod is running and a process to update the k8s job and logs starts. At step S296, network node 16a, e.g., a RSUJC, sends a request to network node 16b, e.g., an RSUJE, to create a network node upgrade job request, and, at step S298, the request of S210 is confirmed. At S300, the network node 16b writes a job record, e.g., to local storage. At step S302, a request to start the network node upgrade job is sent from network node 16a, e.g., RSUJC, to network node 16b, e.g., the RSUJE, which is confirmed at step S304. At step S306, network node 16b, e.g., the RSUJE, writes a job record to local storage. Step S306 (and/or any other steps) may be followed by S308 (and/or any other steps) in FIG. 20B.

FIG. 20B shows an example process of fetching software from a server. At step S308, network node 16b, e.g., the RSUJE, sends a request, e.g., an FTP request to get a binary file, to network node 16e, e.g., a file server, which replies which the requested data at step S310. At step S312, network node 16b sends a request to update the job to network node 16a, the RSUJC, and writes a job record at S314. After step S314, a process to update job and logs starts (e.g., is performed) at network node 16a, e.g., the RSUCE. Step S314 (and/or any other steps) may be followed by S316 (and/or any other steps) in FIG. 20C.

FIG. 20C shows an example process of selecting network node units for the job, and loading and activating software. At step S316, network node 16b, the RSUJE, reads records from storage and selects network nodes 16, e.g., radio units. At step S318, the network node 16b notifies network node 16a, the RSUJC, of the job change. After step S320, network node 16a updates the job and logs. At step S322, a job record is written to storage. A loop is started, and, for every selected network node 16, a selection and activation are made, and, at step S324, network node 16b a job change update is sent to network node 16a, e.g., the RSUJC, which updates the job and logs. At step S326, the network node 16b writes a record a network node record, e.g., a radio unit record. Step S326 (and/or any other steps) may be followed by S328 (and/or any other steps) in FIG. 20D.

FIG. 20D describes an example process of job termination, inspection, and cleanup. At step S328, network node 16b, e.g., the RSUJE, sends a request to update the job to network node 16a, e.g., the RSUJC, which updates the job and logs. At step S330, network node 16b writes a job record. At step S332, an operator makes a request to inspect a k8s job instance at the orchestrator of network node 16c, which makes a request to read k8s job status at step S334, e.g., via a k8s API at step S336. At step S338, the operator makes a request to delete a job instance at the orchestrator of network node 16c, which, at step S340, makes a request to delete the k8s job to the k8s-API. At step S342, the k8s-API makes a request to network node 16a, e.g., the RSUJC, to delete a k8s job resource object. At steps S344-S348, heartbeat indicators are sent from network node 16b, e.g., the RSUJE, to network node 16a, e.g., the RSUJC. After a heartbeat timer expires and the internal job is automatically stopped, at step S350, network node 16b writes a job record.

Although the overall process shown in FIG. 20 shows the process of FIG. 20A occurring first, followed by FIG. 20B, FIG. 20C, and FIG. 20D, the process is not limited as such, and the processes shown in FIGS. 20A-20D may be performed in any order. Further, one or more steps shown in FIGS. 20A-20D may be performed and/or may be performed in any order.

### System-Triggered Software Loading and Activation for Unit in Boot Image

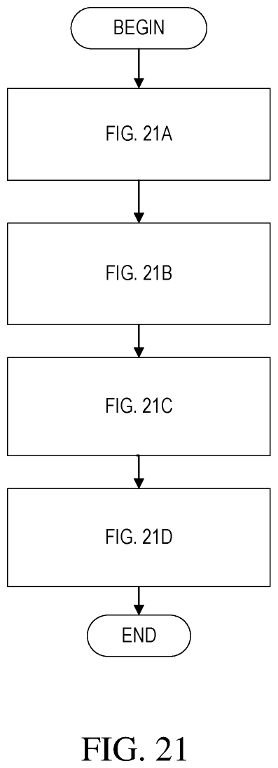

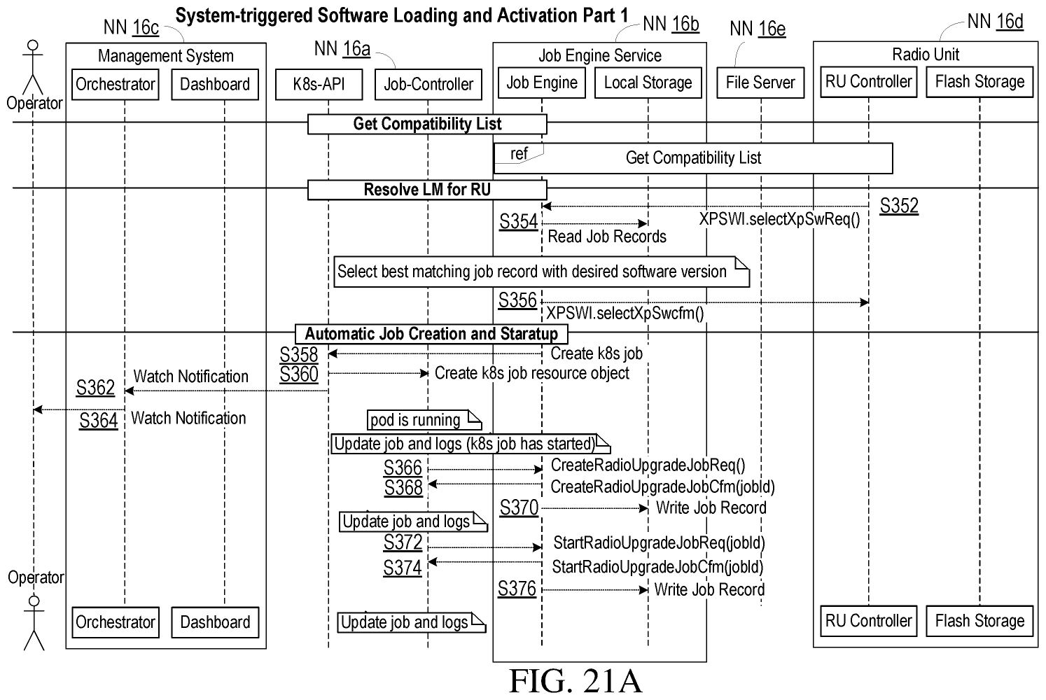

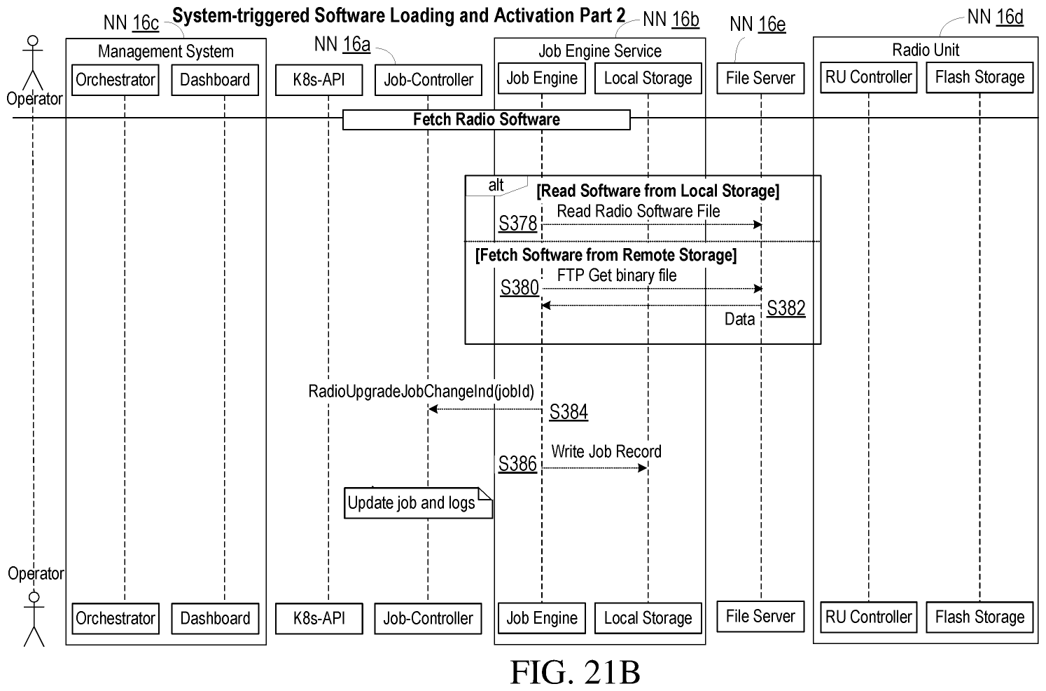

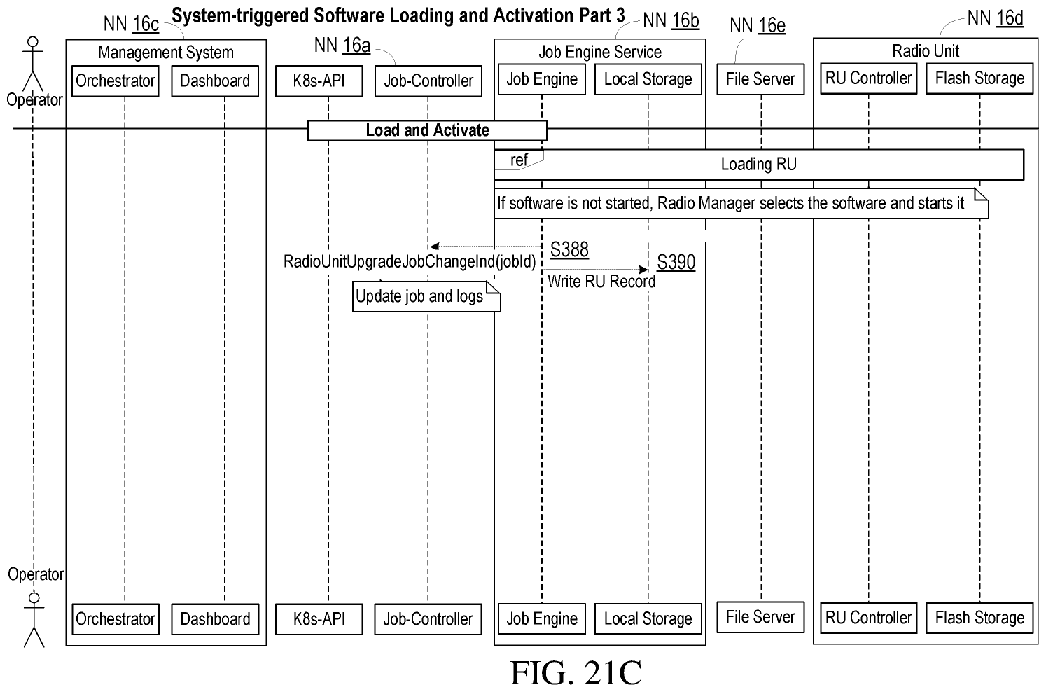

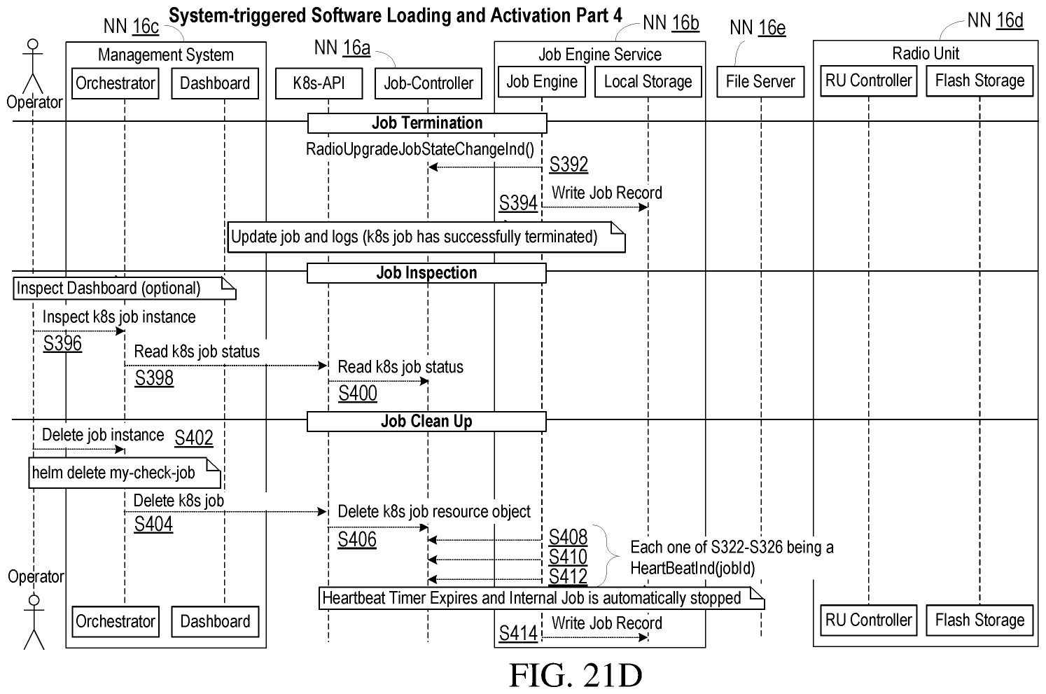

FIG. 21 is an overview of an example process of FIGS. 21A-21D according to some embodiments of the present disclosure. FIGS. 21A-21D show an example process of automatically selecting, downloading, and activating a new software version on a network node 16, e.g., a radio unit in boot image. Before starting the example process, a user-defined radio software upgrade job may be performed with actions to load and activate, such as actions available in inventory which matches a network node 16, e.g., a radio unit.

More specifically, FIG. 21A shows an example process to get a compatibility list, resolve a Load Module (LM) for a network node, e.g., a radio unit, and perform automatic job creation and startup. A compatibility list associated with the network node 16d, e.g., the radio unit, is obtained by network node 16b, e.g., the RSUJE. At step S352, network node 16d, e.g., the radio unit, makes a request to select software requirements to network node 16b, e.g., the RSUJE. At step S354, network node 16b, e.g., the RSUJE, reads job records and selects best matching job record with desired software version. At step S356, a confirmation indicating the selected software is sent to network node 16d, the radio unit. At step S358, network node 16b makes a request to create k8s jobs to a k8s-API, which, at step S360, creates a k8s job resource object and, at step S362 sends a watch notification. The watch notification is made available to the operator at step S264 on the orchestrator of network node 16c. After step S358/S360/S362/S364, pods are running on network node 16a, e.g., the RSUJC, and the job and logs updated. At step S366, network node 16a makes a request to network node 16b to create a network node upgrade job, which is confirmed by network node 16b at step S368. At step S370, network node 16b writes a job record. The job and logs are updated at network node 16a, which, at step S372 makes a request to start the network node upgrade job to network node 16b. Network node 16b confirms the request at step S374 and writes a job record at step S376. After step S2374, the job and logs are updated by network node 16a. Step S376 (and/or any other steps) may be followed by S378 (and/or any other steps) in FIG. 21B.

FIG. 21B shows an example process to fetch network node software, e.g., radio software. At step S378, network node 16b, e.g., the RSUJE, may read a network node software file, e.g., radio software file from local storage. At step S380, network node 16b, e.g., the RSUJE, may make a request to obtain a file, e.g., an FTP get binary file, to network node 16e, e.g., a file server, which replies with data at step S382. At step S384, a request to update the job is sent to network node 16a, e.g., the RSUJC, which updates the job and logs. At step S386, network node 16b writes a job record. Network node 16a updates job and/or logs. Step S386 (and/or any other steps) may be followed by S388 (and/or any other steps) in FIG. 21C.

FIG. 21C shows an example process to load and activate software. Network node 16d is first loaded. At step S388, network node 16, e.g., the RSUJE, makes a request to update a job to network node 16a, e.g., the RSUJC, which updates the job and logs. At step S390, network node 16b writes a network node record, e.g., a radio unit record. Network node 16a updates job and/or logs. Step S390 (and/or any other steps) may be followed by S392 (and/or any other steps) in FIG. 21D.

FIG. 21D describes an example process of job termination, inspection, and cleanup. At step S392, network node 16b, e.g., the RSUJE, sends a request to update the job to network node 16a, e.g., the RSUJC, which updates the job and logs. At step S394, network node 16b writes a job record. At step S3396, an operator makes a request to inspect a k8s job instance at the orchestrator of network node 16c, which makes a request to read k8s job status at step S398, e.g., via a k8s API at step S400. At step S402, the operator makes a request to delete a job instance at the orchestrator of network node 16c, which, at step S404, makes a request to delete the k8s job to the k8s-API. At step S406, the k8s-API makes a request to network node 16a, e.g., the RSUJC, to delete a k8s job resource object. At steps S408-S412, heartbeat indicators are sent from network node 16b, e.g., the RSUJE, to network node 16a, e.g., the RSUJC. After a heartbeat timer expires and the internal job is automatically stopped, at step S414, network node 16b writes a job record.

Although the overall process shown in FIG. 21 shows the process of FIG. 21A occurring first, followed by FIG. 21B, FIG. 21C, and FIG. 21D, the process is not limited as such, and the processes shown in FIGS. 21A-21D may be performed in any order. Further, one or more steps shown in FIGS. 21A-21D may be performed and/or may be performed in any order.

It is noted that logs that may be produced by the RSUJE in the example processes shown in FIGS. 19A-19D, FIGS. 20A-20D, and FIGS. 21A-21D are omitted for ease of understanding.

Further, in some embodiments, network node 16a, e.g., the RSUJC, controls the lifecycle of actual job instances. Network node 16a, e.g., the RSUJC, may also be a job client. Network node 16b, e.g., the RSUJE, may be a job server, execute the job, and/or make changes towards network node 16d, e.g., radio unit or device. Also, network node 16b, e.g., the RSUJE, may also retrieve software from network node 16e, e.g., a file server. Network node 16c, e.g., the management system, may control a lifecycle of network node 16a, e.g., the RSUJC.

In some other embodiments, network node 16a, e.g., the RSUJC, may be integrated into network node 16c, e.g., the management system. In the alternative, network node 16a, e.g., the RSUJC, may be part of a Radio Access Network as a standalone component, where the life of the RSUJC is managed by network node 16c, e.g., the management system acting as an end-to-end orchestrator.

In one embodiment, network node 16c, e.g., the management system one of instantiates the RSUJC and acts as the RSUJC.

In another embodiment, network node 16c, e.g., management system, can be any one of an orchestrator and a k8s API server acting as an orchestrator within a k8s cluster when the RSUJC is instantiated. Also, the RSUJC may send API calls to the RSUJE to create and start jobs.

Further, any network node 16 (such as network node 16b comprising an RSUJE) may be configured to supports one or more ways to fetch the radio software package (e.g., ZIP file):
1. File transfer protocol (FTP), e.g., with username and password;
2. FTP with Transport Layer Security (TLS) and X.509 digital certificates. This is also known as FTPes;
3. Secure FTP (SFTP) (e.g., uses secure shell SSH protocol) with username and password

When one or more RSUJEs are deployed, the operator may decide between them by specifying a URL to a File Server (e.g., configured to store RU software files/packages) which can be realized as FTP Server or SFTP Server, e.g., depending on the operator preference. If the URL starts with ftp, then the #1 or #2 may be selected. For instance: ftp://my-ftp-server:21/radio-software/RADIO-74.1.206-CXF2010002_1-R74A206.zip. Another configuration parameter may be used to enable/disable TLS security. If the URL starts with sftp, then #3 may be selected. For instance: ftp://my-sftp-server:22/radio-software/RADIO-74.1.206-CXF2010002_1-R74A206.zip. In some embodiments, CSAR (Cloud Service Archive) may be used for virtual application software, e.g., to be deployed and run on clouds (i.e., cloud networks). In some other embodiments, a file may refer to a radio software package (such as a ZIP file). In one or more embodiments, the file may be RU CSAR and/or an RU software package. In some embodiments, RU CSAR may refer to RU software package. In one nonlimiting example, a software package for a specific radio unit is a folder (e.g., after extraction) which includes one or more files as follows: applic.sxlf (e.g., software file to download (load) on each radio unit, cxf2010002_1.xml (includes information to be used by the radio software upgrade job engine), and hw_sw_compatibility.xml (includes information to be used by the radio software upgrade job engine).

In some embodiments, one or more ways to deliver and/or deploy the software for the RSUJC and/or RSUJE may be used.
Option #1: RSUJC, RSUJE and vDU applications are delivered to the operator in one or more files, e.g., separate CSARs (A, B and C). This allows the operator to deploy them in 3 different k8s clusters (clouds) or together in the same k8s cluster (cloud network) but using distinct “instance names (to be managed separately).
Option #2: RSUJC is delivered in separate CSAR (A), while RSUJE and vDU applications are delivered together in its own CSAR (D). This allows the operator to deploy and manage the RSUJE together with each vDU instance and deploy or instantiate the RSUJC instance when needed (e.g., during a RU software upgrade) separately from the “always-on” vDU+RSUJE instance.
Option #3: RSUJC, RSUJE and vDU applications are delivered together in a CSAR (E). This allows the operator to deploy, manage and upgrade the radio units attached to the vDU together. This also means the vDU and RSUJE software in the k8s cluster is also upgraded together with the radio software on the physical radio units. Option 3 allows upgrading all (i.e., one or more) parts of the system together.

In some other embodiments, the helm install/delete my-upgrade job is a valid command (case) for deployment option 1 and deployment option 2.

For option 3, the actual helm command may be for the entire vDU+job engine+radio SW controller instance. As an example, when a new vDU instance is deployed, the command may be helm install <name-of-the-vDU-instance> with the name of helm chart provided in the CSAR for option 3 (CSAR E). Such command may also deploy the RSUJE and RSUJC which may trigger a radio software upgrade after the applications in the cloud i.e., vDU+engine+controller are initialized and ready, and the radio units have reconnected to the system. At a next upgrade window, the operator may trigger a helm upgrade of the existing vDU+engine+controller instance which will in turn trigger another radio software upgrade towards the physical radio units.
Option #4: This option may be similar to option #2. The RSUJC is delivered in separate CSAR (A) while RSUJE and vCU applications are delivered together in its own CSAR (F). This allows the operator to deploy and manage the RSUJE together with each vCU instance and deploy or instantiate RSUJC instance when needed (during a RU software upgrade) separately from the “always-on” vCU+Job Engine instance.

The following is a list of nonlimiting example embodiments:

Embodiment A1. A first network node configured to communicate at least with a second network node, the first network node configured to, and/or comprising a radio interface and/or comprising processing circuitry configured to:
control at least a software version associated with at least a fourth network node by sending a job request that causes the second network node to execute at least a job action associated with a software upgrade for at least the fourth network node; and
subscribe to notifications by receiving and collecting information about a progress, a state and error conditions associated at least with the job action for at least the fourth network node.

Embodiment A2. The first network node of Embodiment A1, wherein the first network node is further configured to:
deploy a first job controller configured to perform the control of at least the software version, the deployed first job controller being one of a first type and a second type.

Embodiment A3. The first network node of Embodiment A2, wherein the first network node is further configured to:
communicate with a third network node, the third network node being a management system, the fourth network node being a radio unit having a radio interface and a local storage with a capacity for storing radio unit software, the radio unit software having a radio unit software version;
receive a request associated with the software upgrade from the third network node, the request causing the deployment of the first job controller;
update a plurality of logs associated with the job action; and
the first job controller being a Radio Software Upgrade Job Controller (RSUJC).

Embodiment A4. The first network node of any one of Embodiments A1-A3, wherein the job request is any one of a create job request, a start job request, stop job request, and a delete job request, the create job request includes creating a job record associated with a job within an inventory, the start job request includes starting the job to make the job active within the second network node, the stop job request includes stopping the job to make the job inactive within the second network node, and the delete job request includes deleting the job from the second network node and removing from the inventory the job record associated with the job.

Embodiment A5. The first network node of any one of Embodiments A1-A4, wherein the job action is any one of a load software precheck, a load software action, an activate software pre-check, an activate software action, and an activate software post-check, the load software precheck including performing a software compatibility precheck at least on the fourth network node before one of downloading and activating a new software, the load software action including downloading a new software version at least to the fourth network node, the activate software pre-check including performing a precheck at least on the fourth network node before activating the new software, the activate software action includes activating the new software at least on the fourth network node, the activate software post-check including performing a post-check at least on the fourth network node after activating the new software.

Embodiment A6. The first network node of Embodiment A2, wherein the second network node includes a deployed job engine, the deployed job engine being a Radio Software Upgrade Job Engine (RUSJE) of the second type.

Embodiment A7. The first network node of Embodiment A2, wherein the first type is a k8s Job running on a workload cluster, and the second type is a k8s Deployment running on a workload cluster.

Embodiment A8. The first network node of Embodiment A3, wherein the first network node is any one of:
configured based at least in part on a Cloud Service Archive (CSAR);
instantiated by the third network node;
a standalone job controller; and
running within one of the second network node and the third network node.

Embodiment A9. The first network node of Embodiment A2, wherein the first job controller is any job controller of a plurality of job controllers and is running on anyone of an element manager and a cloud management system.

Embodiment B1. A method implemented in a first network node that is configured to communicate at least with a second network node, to the method including:
controlling at least a software version associated with at least a fourth network node by sending a job request that causes the second network node to execute at least a job action associated with a software upgrade for at least the fourth network node; and
subscribing to notifications by receiving and collecting information about a progress, a state and error conditions associated at least with the job action for at least the fourth network node.

Embodiment B2. The method of Embodiment B1, the method further including:
deploying a first job controller configured to perform the control of at least the software version, the deployed first job controller being one of a first type and a second type.

Embodiment B3. The method of Embodiment B2, the method further including:
communicating with a third network node, the third network node being a management system, the fourth network node being a radio unit having a radio interface and a local storage with a capacity for storing radio unit software, the radio unit software having a radio unit software version;
receiving a request associated with the software upgrade from the third network node, the request causing the deployment of the first job controller;
updating a plurality of logs associated with the job action; and
the first job controller being a Radio Software Upgrade Job Controller (RSUJC).

Embodiment B4. The method of any one of Embodiments B1-B3, wherein the job request is any one of a create job request, a start job request, stop job request, and a delete job request, the create job request includes creating a job record associated with a job within an inventory, the start job request includes starting the job to make the job active within the second network node, the stop job request includes stopping the job to make the job inactive within the second network node, and the delete job request includes deleting the job from the second network node and removing from the inventory the job record associated with the job.

Embodiment B5. The method of any one of Embodiments B1-B4, wherein the job action is any one of a load software precheck, a load software action, an activate software pre-check, an activate software action, and an activate software post-check, the load software precheck including performing a software compatibility precheck at least on the fourth network node before one of downloading and activating a new software, the load software action including downloading a new software version at least to the fourth network node, the activate software pre-check including performing a precheck at least on the fourth network node before activating the new software, the activate software action includes activating the new software at least on the fourth network node, the activate software post-check including performing a post-check at least on the fourth network node after activating the new software.

Embodiment B6. The method of Embodiment B2, wherein the second network node includes a deployed job engine, the deployed job engine being a Radio Software Upgrade Job Engine (RUSJE) of the second type.

Embodiment B7. The method of Embodiment B2, wherein the first type is a k8s Job running on a workload cluster, and the second type is a k8s Deployment running on a workload cluster.

Embodiment B8. The method of Embodiment B3, wherein the first network node is any one of:
configured based at least in part on a Cloud Service Archive (CSAR);
instantiated by the third network node;
a standalone job controller; and
running within one of the second network node and the third network node.

Embodiment B9. The method of Embodiment B2, wherein the first job controller is any job controller of a plurality of job controllers and is running on anyone of an element manager and a cloud management system.

Embodiment C1. A second network node configured to communicate at least with a first network node and a fourth network node, the second network node configured to, and/or comprising a radio interface and/or comprising processing circuitry configured to:
receive a job request associated with a software upgrade for at least the fourth network node, the job request being received from the first network node and causing the second network node to execute at least a job action associated with the software upgrade;
execute at least the job action;
update a plurality of logs associated with the job action; and
send notifications associated at least with the job action to the first network node.

Embodiment C2. The second network node of Embodiment C1, the second network node being further configured to:
deploy a job engine within the second network node to execute at least the job action, the deployed job engine being a Radio Software Upgrade Job Engine (RUSJE) of a first type, the first type being a k8s Deployment.

Embodiment C3. The second network node of any one of Embodiments C1 and C2, the second network node being further configured to:
communicate with a third network node, the third network node being a management system;
download to the fourth network node a radio unit software associated with the software upgrade, the fourth network node being a radio unit having a radio interface and a local storage with a capacity for storing the radio unit software, the radio unit software having a radio unit software version; and
cause the fourth network node to perform the software upgrade.

Embodiment C4. The second network node of any one of Embodiments C1-C3, the second network node being further configured to:
write a record of a plurality of records to an inventory; and
read the record of plurality of records from the inventory, each record of the plurality of records being one of a network node record and a job record, the inventory being one of a local database and a remote database.

Embodiment C5. The second network node of any one of Embodiments C1-C4, the second network node being further configured to:
enable a Radio Software Upgrade Control Interface (RSUCI), the RSUCI generating a mapping between LCM operations and a plurality of signals and setting up a server socket for at least one network node to establish a connection as a client, the connection being a Transmission Control Protocol (TCP) connection over Transport Layer Security (TLS) and allowing the second network node to any one of:
   receive the job request to execute at least the job action; and
   transmit information about a progress, a state and error conditions associated at least with the job request for at least the fourth network node.

Embodiment C6. The second network node of any one of Embodiments C1-C5, wherein the first network node is within the second network node.

Embodiment C7. The second network node of Embodiment C4, wherein the second network node is further configured to:
receive a dashboard request to read the record of the plurality of records from the inventory; and
transmit the read record.

Embodiment C8. The second network node of any one of Embodiments C1-C7, wherein the second network node is further configured to:
fetch data from a fifth network node, the fifth network node being a file server, the fetched data being associated with the software upgrade.

Embodiment C9. The second network node any of Embodiments C1-C8, wherein the software upgrade is retrieved from a local storage.

Embodiment C10. The second network node of any one of Embodiments C1-C9, wherein the second network node is further configured to:
read a compatibility list from the fourth network node; and
determine whether the fourth network node is compatible with the software upgrade.

Embodiment C11. The second network node of Embodiment C4, wherein the second network node is further configured to:
write the record of a plurality of records to the inventory in response to an expiration of a heartbeat timer.

Embodiment C12. The second network node of anyone of Embodiments C1-C11, wherein the second network node is configured based at least in part on a Cloud Service Archive (CSAR).

Embodiment C13. The second network node of any one of Embodiments C4, wherein the job request is any one of a create job request, a start job request, stop job request, and a delete job request, the create job request includes creating a job record associated with a job within the inventory, the start job request includes starting the job to make the job active within the second network node, the stop job request includes stopping the job to make the job inactive within the second network node, and the delete job request includes deleting the job from the second network node and removing from the inventory the job record associated with the job.

Embodiment D1. A method implemented in a second network node that is configured to communicate at least with a first network node and a fourth network node, the method including:
receiving a job request associated with a software upgrade for at least the fourth network node, the job request being received from the first network node and causing the second network node to execute at least a job action associated with the software upgrade;
executing at least the job action;
updating a plurality of logs associated with the job action; and
sending notifications associated at least with the job action to the first network node.

Embodiment D2. The method of Embodiment D1, the method further including:
deploying a job engine within the second network node to execute at least the job action, the deployed job engine being a Radio Software Upgrade Job Engine (RUSJE) of a first type, the first type being a k8s Deployment.

Embodiment D3. The method of any one of Embodiments D1 and D2, the method further including:
communicating with a third network node, the third network node being a management system;
downloading to the fourth network node a radio unit software associated with the software upgrade, the fourth network node being a radio unit having a radio interface and a local storage with a capacity for storing the radio unit software, the radio unit software having a radio unit software version;
causing the fourth network node to perform the software upgrade.

Embodiment D4. The method of any one of Embodiments D1-D3, the method further including:
writing a record of a plurality of records to an inventory; and
reading the record of plurality of records from the inventory, each record of the plurality of records being one of a network node record and a job record, the inventory being one of a local database and a remote database.

Embodiment D5. The method of any one of Embodiments D1-D4, the method further including:
enabling a Radio Software Upgrade Control Interface (RSUCI), the RSUCI generating a mapping between LCM operations and a plurality of signals and setting up a server socket for at least one network node to establish a connection as a client, the connection being a Transmission Control Protocol (TCP) connection over Transport Layer Security (TLS) and allowing the second network node to any one of:
   receive the job request to execute at least the job action; and
   transmit information about a progress, a state and error conditions associated at least with the job request for at least the fourth network node.

Embodiment D6. The method of any one of Embodiments D1-D5, wherein the first network node is within the second network node.

Embodiment D7. The method of Embodiment D4, the method further including:
receiving a dashboard request to read the record of the plurality of records from the inventory; and
transmitting the read record.

Embodiment D8. The method of any one of Embodiments D1-D7, the method further including:
fetching data from a fifth network node, the fifth network node being a file server, the fetched data being associated with the software upgrade.

Embodiment D9. The method any of Embodiments D1-D8, wherein the software upgrade is retrieved from a local storage.

Embodiment D10. The method of any one of Embodiments D1-D9, the method further including:
reading a compatibility list from the fourth network node; and
determining whether the fourth network node is compatible with the software upgrade.

Embodiment D11. The method of Embodiment D4, the method further including:
writing the record of a plurality of records to the inventory in response to an expiration of a heartbeat timer.

Embodiment D12. The method of anyone of Embodiments D1-D11, wherein the second network node is configured based at least in part on a Cloud Service Archive (CSAR).

Embodiment D13. The method of Embodiment D4, wherein the job request is any one of a create job request, a start job request, stop job request, and a delete job request, the create job request includes creating a job record associated with a job within the inventory, the start job request includes starting the job to make the job active within the second network node, the stop job request includes stopping the job to make the job inactive within the second network node, and the delete job request includes deleting the job from the second network node and removing from the inventory the job record associated with the job.

Embodiment E1. A third network node configured to manage a software upgrade of at least a fourth network node, the third network node configured to, and/or comprising a radio interface and/or comprising processing circuitry configured to:
receive at least a file associated with the software upgrade;
manage a life cycle of the software upgrade, the life cycle including at least a job action associated at least with the software upgrade; and
visualize at least the job action associated at least with the software upgrade.

Embodiment E2. The third network node of Embodiment E1, wherein at least the file associated with the software upgrade is received by an on-boarding manager and visualizing at least the job action associated at least with the software upgrade is provided by a dashboard, and the third network node is further configured to:
manage logs associated with the software upgrade.

Embodiment E3. The third network node of any one of Embodiments E1 and E2, wherein receiving at least the file associated with the software upgrade includes receiving a Cloud Service Archive (CSAR).

Embodiment E4. The third network node of any one of Embodiments E1-E3, wherein managing the life cycle of the software upgrade includes communicating with a first network node, the first network node is a Radio Software Upgrade Job Controller (RUSJC) and one of a standalone job controller and running within the third network node, the RUSJC is one of a k8s Job and a k8s Deployment, and managing the life cycle of the software upgrade further includes performing any one of:
creating the job action associated at least with the software upgrade;
inspecting the job action associated at least with the software upgrade; and
deleting the job action associated at least with the software upgrade.

Embodiment E5. The third network node of any one of Embodiments E1-E4, wherein visualizing at least the job action associated at least with the software upgrade includes any one of:
requesting from a second network node at least a record associated with the software upgrade, the second network node being a Radio Software Upgrade Job Engine (RUSJE), the RSUJE being a k8s Deployment, the record being one of a network node record and a job record; and
requesting software data associated with the software upgrade from a fifth network node, the fifth network node being a file server.

Embodiment E6. The third network node of Embodiment E4, wherein the third network node is a management system, the management system being at least in part any one of an orchestrator and a k8s API server acting as the orchestrator within a k8s cluster when the first network node is instantiated.

Embodiment F1. A method implemented in a third network node that is configured to manage a software upgrade of at least a fourth network node, the method including:
receiving at least a file associated with the software upgrade;
managing a life cycle of the software upgrade, the life cycle including at least a job action associated at least with the software upgrade; and
visualizing at least the job action associated at least with the software upgrade.

Embodiment F2. The method of Embodiment F1, wherein at least the file associated with the software upgrade is received by an on-boarding manager, and visualizing at least the job action associated at least with the software upgrade is provided by a dashboard, and the method further including:
managing logs associated with the software upgrade.

Embodiment F3. The method of any one of Embodiments F1 and F2, wherein receiving at least the file associated with the software upgrade includes receiving a Cloud Service Archive (CSAR).

Embodiment F4. The method of any one of Embodiments F1-F3, wherein managing the life cycle of the software upgrade includes communicating with a first network node, the first network node is a Radio Software Upgrade Job Controller (RUSJC) and one of a standalone job controller and running within the third network node, the RUSJC is one of a k8s Job and a k8s Deployment, and managing the life cycle of the software upgrade further includes performing any one of:
creating the job action associated at least with the software upgrade;
inspecting the job action associated at least with the software upgrade; and
deleting the job action associated at least with the software upgrade.

Embodiment F5. The method of any one of Embodiments F1-F4, wherein visualizing at least the job action associated at least with the software upgrade includes any one of:
requesting from a second network node at least a record associated with the software upgrade, the second network node being a Radio Software Upgrade Job Engine (RUSJE), the RSUJE being a k8s Deployment, the record being one of a network node record and a job record; and
requesting software data associated with the software upgrade from a fifth network node, the fifth network node being a file server.

Embodiment F6. The method of Embodiment F4, wherein the third network node is a management system, the management system being at least in part any one of an orchestrator and a k8s API server acting as the orchestrator within a k8s cluster when the first network node is instantiated.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A first network node configured to communicate at least with a second network node, the first network node comprising processing circuitry configured to:
control at least a software version associated with at least a fourth network node by sending a job request that causes the second network node to execute at least a job action associated with a software upgrade for at least the fourth network node.

2. The first network node of claim 1, wherein the processing circuitry is further configured to:
deploy a first job controller configured to perform the control of at least the software version, the deployed first job controller being one of a first type and a second type.

3. The first network node of claim 2, wherein the first job controller is a Radio Software Upgrade Job Controller, RSUJC.

4. The first network node of claim 2, wherein the first network node is further configured to communicate with a third network node, the third network node being a management system, the first network node further comprising a communication interface configured to:
receive a request associated with the software upgrade from the third network node, the request causing the deployment of the first job controller; and
the processing circuitry is further configured to update a plurality of logs associated with the job action.

5. The first network node of claim 1, wherein the fourth network node is a radio unit having a radio interface and a local storage with a capacity for storing radio unit software, the radio unit software having a radio unit software version.

6. The first network node of claim 1, wherein the job request is any one of a create job request, a start job request, stop job request, and a delete job request, the create job request includes creating a job record associated with a job within an inventory, the start job request includes starting the job to make the job active within the second network node, the stop job request includes stopping the job to make the job inactive within the second network node, and the delete job request includes deleting the job from the second network node and removing from the inventory the job record associated with the job.

7. The first network node of claim 1, wherein the job action is any one of a load software precheck, a load software action, an activate software pre-check, an activate software action, and an activate software post-check, the load software precheck including performing a software compatibility precheck at least on the fourth network node before one of downloading and activating a new software, the load software action including downloading a new software version at least to the fourth network node, the activate software pre-check including performing a precheck at least on the fourth network node before activating the new software, the activate software action including activating the new software at least on the fourth network node, the activate software post-check including performing a post-check at least on the fourth network node after activating the new software.

8. The first network node of claim 1, wherein the second network node includes a deployed job engine, the deployed job engine being a Radio Software Upgrade Job Engine, RUSJE, of the second type.

9. The first network node of claim 2, wherein the first type is a k8s Job running on a workload cluster, and the second type is a k8s Deployment running on a workload cluster.

10. The first network node of claim 4, wherein the first network node is any one of:
configured based at least in part on a file;
instantiated by the third network node;
a standalone job controller; and
running within one of the second network node and the third network node.

11. The first network node of claim 10, wherein the file is Cloud Service Archive, CSAR.

12. The first network node of claim 2, wherein the first job controller is any job controller of a plurality of job controllers and is running on anyone of an element manager and a cloud management system.

13. The first network node of claim 1, wherein the processing circuitry is further configured to cause the first network node to:
subscribe to notifications by receiving and collecting information about a progress, a state and error conditions associated at least with the job action for at least the fourth network node.

14. A method implemented in a first network node that is configured to communicate at least with a second network node, to the method comprising:
controlling at least a software version associated with at least a fourth network node by sending a job request that causes the second network node to execute at least a job action associated with a software upgrade for at least the fourth network node.

15. The method of claim 14, wherein the method further includes:
deploying a first job controller configured to perform the control of at least the software version, the deployed first job controller being one of a first type and a second type.

16. The method of claim 15, wherein the first job controller is a Radio Software Upgrade Job Controller, RSUJC.

17. The method of claim 15, wherein the first network node is further configured to communicate with a third network node, the third network node being a management system, and the method further includes:
receiving a request associated with the software upgrade from the third network node, the request causing the deployment of the first job controller; and
updating a plurality of logs associated with the job action.

18. The method of claim 14, wherein the fourth network node is a radio unit having a radio interface and a local storage with a capacity for storing radio unit software, the radio unit software having a radio unit software version.

19. The method of claim 14, wherein the job request is any one of a create job request, a start job request, stop job request, and a delete job request, the create job request includes creating a job record associated with a job within an inventory, the start job request includes starting the job to make the job active within the second network node, the stop job request includes stopping the job to make the job inactive within the second network node, and the delete job request includes deleting the job from the second network node and removing from the inventory the job record associated with the job.

20. The method of claim 14, wherein the job action is any one of a load software precheck, a load software action, an activate software pre-check, an activate software action, and an activate software post-check, the load software precheck including performing a software compatibility precheck at least on the fourth network node before one of downloading and activating a new software, the load software action including downloading a new software version at least to the fourth network node, the activate software pre-check including performing a precheck at least on the fourth network node before activating the new software, the activate software action including activating the new software at least on the fourth network node, the activate software post-check including performing a post-check at least on the fourth network node after activating the new software.

21. The method of claim 14, wherein the second network node includes a deployed job engine, the deployed job engine being a Radio Software Upgrade Job Engine, RUSJE, of the second type.

22. The method of claim 15, wherein the first type is a k8s Job running on a workload cluster, and the second type is a k8s Deployment running on a workload cluster.

23. The method of claim 17, wherein the first network node is any one of:
configured based at least in part on a file;
instantiated by the third network node;
a standalone job controller; and
running within one of the second network node and the third network node.

24. The method of claim 23, wherein the file is Cloud Service Archive, CSAR.

25. The method of claim 15, wherein the first job controller is any job controller of a plurality of job controllers and is running on anyone of an element manager and a cloud management system.

26. The method of claim 14, wherein the method further includes:
subscribing to notifications by receiving and collecting information about a progress, a state and error conditions associated at least with the job action for at least the fourth network node.

27.-74. (canceled)
